(19) United States
(12) Patent Application Publication
(10) Pub. No.: US 2026/0278399 A1
(43) Pub. Date: Sep. 17, 2026

(54) METHOD AND SYSTEM FOR GENERATING AN ENSEMBLE LOGISTIC BANDIT MODEL FOR PREDICTING AN OPTIMAL ELECTRONIC DOCUMENT SENDING TIME

(71) Applicant: JPMorgan Chase Bank, N.A., New York, NY (US)

(72) Inventors: Subhabrata DAS, Hoboken, NJ (US); Maryam KABIRI, Allendale, NJ (US); Harring FIGUEIREDO, Alpharetta, GA (US); Sujay BHATT, Fresh Meadows, NY (US); Alec KOPPEL, New York, NY (US)

(73) Assignee: JPMorgan Chase Bank, N.A., New York, NY (US)

(21) Appl. No.: 19/076,332

(22) Filed: Mar. 11, 2025

(51) Int. Cl. G06N 3/0985; G06N 3/045

(52) U.S. Cl. CPC G06N 3/0985; G06N 3/045

(57) ABSTRACT

A method and system for generating a contextual-based cluster assignment bandit model for predicting an optimal electronic document sending time. The method includes receiving input data related to an electronic document transmission, and extracting contextual features from the input data. The method also includes generating a contextual-based cluster assignment bandit model (CBCABM) based on the extracted contextual features representing an arm of the CBCABM and based on a selection of at least one learning algorithm from among a plurality of learning algorithms that maximizes an expected reward function for the CBCABM. The method also include predicting an action comprising an optimal electronic document sending time as derived from the CBCABM, and outputting the predicted action to a user.

### FIELD OF THE DISCLOSURE

This technology generally relates to methods and systems for generating a contextual-based cluster assignment bandit model for predicting of a recommended optimal electronic document sending time based on contextual information that defines an ensemble or binning procedures to embed into a base context free bandit model, enabling an optimized interface with third-party electronic document sending applications.

### BACKGROUND INFORMATION

In private enterprises, the ability to sign and execute electronic documents (e.g., contracts, agreements, etc.) is of paramount importance because it enables business to be conducted globally in a convenient, accessible, and efficient manner. However, given the vast volume of the electronic documents that needs to be signed for any given business organization, a technique is needed to better manage the signing of these electronic documents. Notably, techniques for managing when such electronic documents should be sent out for signing.

As such, within a business context, the implementation of a model (e.g., a machine learning model) for recommending electronic document signing would have significant implications across various operational facets. For instance, such a model is needed to determine an optimal timeframe to send the electronic document to ensure that it will be signed and to stagger the sending of these electronic documents to expedite a client induction process and reduce the turn time associated with the electronic document signing, as well as preventing network and/or bandwidth congestion to ensure efficient system resource usage.

Accordingly, there is a need for techniques to determine an optimized timeframe to send electronic documents.

### SUMMARY

The present disclosure, through one or more of its various aspects, embodiments, and/or specific features or sub-components, provides, inter alia, various systems, servers, devices, methods, media, programs, and platforms for generating a contextual multi-armed bandit model for predicting an optimal electronic document sending time.

According to an aspect of the present disclosure, a method of generating a contextual-based cluster assignment bandit model (CBCABM) for predicting an optimal electronic document sending time may be provided. The method may be implemented by at least one processor. The method may include receiving input data related to an electronic document transmission and extracting contextual features from the input data. The method may also include generating a contextual-based cluster assignment bandit model (CBCABM) based on the extracted contextual features representing an arm of the CBCABM and based on a selection of at least one learning algorithm from among a plurality of learning algorithms that maximizes an expected reward function for the CBCABM. The method may also include predicting an action comprising an optimal electronic document sending time as derived from the CBCABM, and outputting the predicted action to a user.

The input data comprises a user metric, a document attribute, and a historical interaction data. The user metric comprises a user demographic and a user identification. The document attribute comprises a document type and an urgency identifier. The historical interaction data comprises at least one from among a historical sending time, a past action, and a past outcome.

The method may further include training the CBCABM based on the historical interaction data to estimate a reward associated with the predicted action that maximizes the expected reward function. The method may further include performing a feedback loop mechanism as part of the training of the CBCABM. The method may further include updating the CBCABM by fine-tuning hyperparameters of the CBCABM in conjunction with an updating rule associated with the selected at least one learning algorithm.

The updating rule comprises at least one from among a gradient descent function, a distance measurement function, a cosine similarity function, and a probability function. The feedback loop mechanism is based on at least one from among a user feedback, a performance evaluation of the CBCABM, and a changing need of a business organization that utilizes the CBCABM.

The method may further include performing the feedback loop mechanism by performing an evaluation of the CBCABM based on a predetermined evaluation framework with a predetermined performance threshold metric based on a mean and a standard deviation of a rewards distribution.

The CBCABM may include a reinforcement learning model. The plurality of learning algorithms may include a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHN) learning algorithm, a cluster learning algorithm, a radius neighborhood learning algorithm, and a tree bandit learning algorithm. The expected reward function may include an argmax function with an estimated reward term representing an exploitation concept and a confidence interval representing an exploration concept.

The method may further include optimizing an epsilon-greedy algorithm based on adjusting an epsilon value to provide a balance between an exploitation concept and an exploration concept associated with a performance of the CBCABM.

According to another embodiment, a computing apparatus for generating a contextual-based cluster assignment bandit model (CBCABM) for predicting an optimal electronic document sending time may be provided. The computing apparatus may include: a processor; a memory; a display; and a communication interface coupled to each of the processor, the memory, and the display.

The processor may be configured to receive input data related to an electronic document transmission, and extract contextual features from the input data. The processor may be configured to generate a contextual-based cluster assignment bandit model (CBCABM) based on the extracted contextual features representing an arm of the CBCABM and based on a selection of at least one learning algorithm from among a plurality of learning algorithms that maximizes an expected reward function for the CBCABM. The processor may be configured to predict an action comprising an optimal electronic document sending time as derived from the CBCABM, and output the predicted action to a user.

The input data may include a user metric, a document attribute, and a historical interaction data. The user metric may include a user demographic and a user identification. The document attribute may include a document type and an urgency identifier. The historical interaction data may include at least one from among a historical sending time, a past action, and a past outcome.

The processor may be further configured to train the CBCABM based on the historical interaction data to estimate a reward associated with the predicted action that maximizes the expected reward function. The processor may be further configured to perform a feedback loop mechanism as part of the training of the CBCABM. The processor may be further configured to update the CBCABM by fine-tuning hyperparameters of the CBCABM in conjunction with an updating rule associated with the selected at least one learning algorithm.

The updating rule comprises at least one from among a gradient descent function, a distance measurement function, a cosine similarity function, and a probability function. The feedback loop mechanism may be based on at least one from among a user feedback, a performance evaluation of the CBCABM, and a changing need of a business organization that utilizes the CBCABM.

The processor may be further configured to perform the feedback loop mechanism by performing an evaluation of the CBCABM based on a predetermined evaluation framework with a predetermined performance threshold metric based on a mean and a standard deviation of a rewards distribution.

The CBCABM may include a reinforcement learning model. The plurality of learning algorithms may include a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHN) learning algorithm, a cluster learning algorithm, a radius neighborhood learning algorithm, and a tree bandit learning algorithm. The expected reward function may include an argmax function with an estimated reward term representing an exploitation concept and a confidence interval representing an exploration concept.

The processor may be further configured to optimize an epsilon-greedy algorithm based on adjusting an epsilon value to provide a balance between an exploitation concept and an exploration concept associated with a performance of the CBCABM.

According to yet another embodiment, non-transitory computer readable storage medium storing instructions for generating a contextual-based cluster assignment bandit model for predicting an optimal electronic document sending time may be provided. The non-transitory computer readable storage medium may include executable code which, when executed by a processor, may cause the processor to receive input data related to an electronic document transmission, and extract contextual features from the input data. The non-transitory computer readable storage medium may also cause the processor to generate a contextual-based cluster assignment bandit model (CBCABM) based on the extracted contextual features representing an arm of the CBCABM and based on a selection of at least one learning algorithm from among a plurality of learning algorithms that maximizes an expected reward function for the CBCABM.

The non-transitory computer readable storage medium may also cause the processor to predict an action comprising an optimal electronic document sending time as derived from the CBCABM, and output the predicted action to a user.

The input data may include a user metric, a document attribute, and a historical interaction data. The user metric may include a user demographic and a user identification. The document attribute may include a document type and an urgency identifier. The historical interaction data may include at least one from among a historical sending time, a past action, and a past outcome. The CBCABM may include a reinforcement learning model.

The plurality of learning algorithms may include a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHN) learning algorithm, a cluster learning algorithm, a radius neighborhood learning algorithm, and a tree bandit learning algorithm. The expected reward function may include an argmax function with an estimated reward term representing an exploitation concept and a confidence interval representing an exploration concept.

The non-transitory computer readable storage medium may further cause the processor to train the CBCABM based on the historical interaction data to estimate a reward associated with the predicted action that maximizes the expected reward function. The non-transitory computer readable storage medium may further cause the processor to perform a feedback loop mechanism as part of the training of the CBCABM. The non-transitory computer readable storage medium may further cause the processor to update the CBCABM by fine-tuning hyperparameters of the CBCABM in conjunction with an updating rule associated with the selected at least one learning algorithm.

The updating rule may include at least one from among a gradient descent function, a distance measurement function, a cosine similarity function, and a probability function. The feedback loop mechanism may be based on at least one from among a user feedback, a performance evaluation of the CBCABM, and a changing need of a business organization that utilizes the CBCABM.

The non-transitory computer readable storage medium may further cause the processor to perform the feedback loop mechanism by performing an evaluation of the CBCABM based on a predetermined evaluation framework with a predetermined performance threshold metric based on a mean and a standard deviation of a rewards distribution.

The non-transitory computer readable storage medium may further cause the processor to optimize an epsilon-greedy algorithm based on adjusting an epsilon value to provide a balance between an exploitation concept and an exploration concept associated with a performance of the CBCABM.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for generating a contextual-based cluster assignment bandit model (CBCABM) for predicting an optimal electronic document sending time.

FIG. 4 illustrates a flowchart of a process diagram for generating a CMCABM for predicting an optimal electronic document sending time according to an embodiment.

FIG. 5 illustrates an example framework of the CMCABM according to an embodiment.

FIG. 6 illustrates example learning algorithms for utilization in the CMCABM according to an embodiment.

### DETAILED DESCRIPTION

In private enterprises, the ability to sign and execute electronic documents (e.g., contracts, agreements, etc.) is of paramount importance because it enables business to be conducted globally in a convenient, accessible, and efficient manner. However, given the vast volume of the electronic documents that needs to be signed for any given business organization, a technique is needed to better manage the signing of these electronic documents. Notably, techniques for managing when such electronic documents should be sent out for signing.

Indeed, within an electronic document workflow in the status quo, there is a lack of an optimized system for recommending the optimal times to send electronic documents via e.g., an electronic document signing platform. This can lead to inefficiencies, such as delays in electronic document processing and lower engagement rates from recipients of those electronic documents.

Without these data-driven insights into optimal sending times, electronic documents may be sent when recipients are less likely to engage promptly, resulting in extended turnaround times and potential bottlenecks in workflow processes. The absence of such a model (e.g., a machine learning model) that leverages historical data and recipient behavior patterns means missed opportunities to enhance efficiency and user satisfaction. Addressing this gap can lead to improved electronic document processing times, higher recipient engagement, and overall better resource utilization. Thus, such a model is needed that can identify and suggest the most effective sending times for electronic documents as tailored to recipient behavior and organizational needs, enabling operational streamlining and enhanced productivity.

As such, within a business context, the implementation of such a model (e.g., a machine learning model) for recommending electronic document signing would have significant implications across various operational facets. For instance, such a model is needed to determine an optimal timeframe to send the electronic document to ensure that it will be signed and to expedite a client induction process and reduce the turn time associated with the electronic document signing, as well as preventing network and/or bandwidth congestion and to ensure efficient system resource usage. In the present application, the model is a contextual-based cluster assignment bandit model (CBCABM) that incorporates various algorithms. The CBCABM comprising reinforcement learning.

Indeed, a contextual bandit model like the CBCABM may be utilized as a type of model for making predictions/recommendations of optimal electronic document sending times. The contextual bandit model may seek to optimize the response time at a next step, predicated on a conditional independence assumption. Thus, making the CBCABM ideal for situations wherein each response is effectively captured by a statistical model that maps input features and choice of recommendation to a predicted response time, which is typical of recommendation systems.

To enable the CBCABM for practical implementation in financial application, the CBCABM should be operable in an offline setting, wherein a fixed batch of prior covariates of fixed dimensionality (i.e., context) are available, alongside rewards for past selected recommendation. The CBCABM may choose an arm (e.g., an action or a strategy) for that round, and the result may reveal a reward for that arm, but not for the other arms. Thus, given access to historical trajectory information, a goal of the CBCABM may be to make a prediction of alternate recommendations that can result in higher reward. This process may be repeated iteratively as the size of a data batch grows over time, e.g., in a cache.

As such, within the realm of business services delivered, the CBCABM plays a crucial role in optimizing electronic document-related processes, ensuring a seamless and efficient operational system workflow. This may translate into improved electronic document delivery service, reducing turnaround times and enhancing the overall client experience. Moreover, when it comes to electronic document signing times, the CBCABM may intelligently suggest relevant times for sending electronic documents to clients based on the context of the electronic documents involved, thereby fostering upselling opportunities and tailoring product recommendations to specific user's needs.

Additionally, in managing the business needs and the users served, the CBCABM may aid in personalized interactions, contributing to stronger relationships and increased user satisfaction. The CBCABM's application may also be applied to outstanding dollar amounts for streamlining financial transactions, reducing electronic paperwork, and expediting the completion of electronic agreements. Thus, positively impacting the overall financial efficiency of the business. In essence, the CBCABM proves instrumental in harmonizing electronic services, electronic products, users, and financial processes within a business framework.

The present application improves on the status quo and provides a technological improvement by disclosing techniques and processes related to the CBCABM and its generation, which includes training and fine-tuning, to improve electronic documents operation and improving system resource usage. This may be achieved by providing e.g., predictions/recommendations of optimal electronic document sending times to ensure that the electronic document will be signed and to expedite a client induction process and reduce the turn time associated with the electronic document signing, enabling a reduction in network and/or bandwidth congestion. Thus, improving system resource usage. Additionally, the generation of the CBCABM in the particular manner as described in the present application also provides a technological improvement through its dynamic analysis, selection, and incorporation of a learning algorithm from a plurality of learning algorithms that best meets the conditions of a given task.

For these various reasons, the present application provides a technological improvement of the status quo. Further details of the present application are provided below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

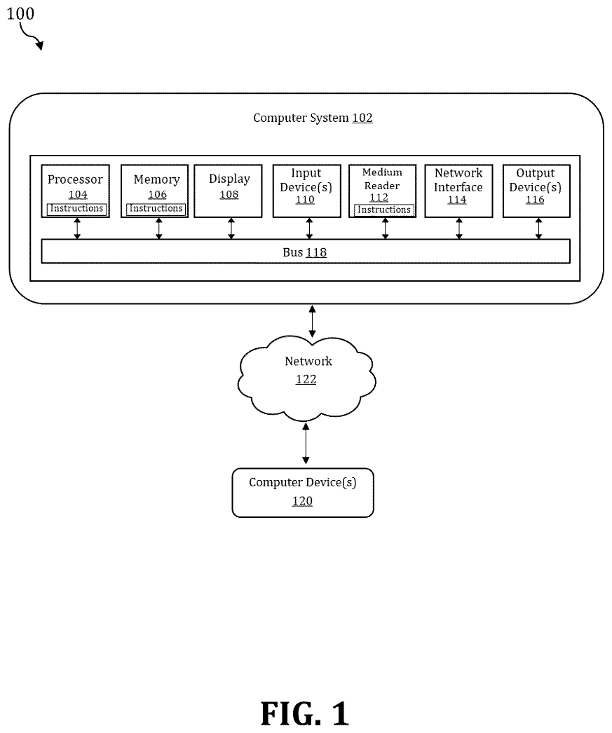

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for generating a CBCABM for predicting an optimal electronic document sending time.

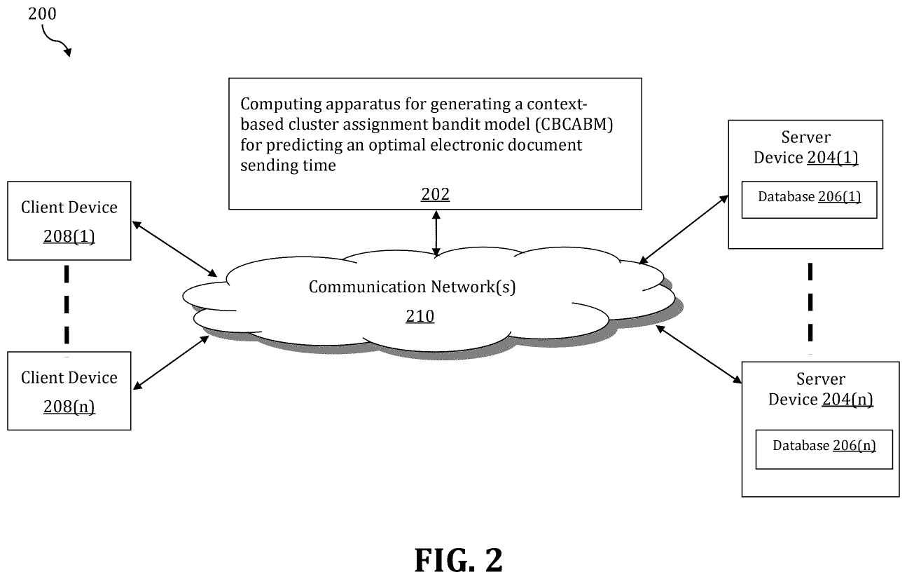

Referring to FIG. 2, a network diagram of a network environment 200 for generating a CBCABM for predicting an optimal electronic document sending time may be illustrated. In an embodiment, the method may be executable on any networked computer platform, such as, for example, a personal computer (PC).

The methods for generating a CBCABM for predicting an optimal electronic document sending time may be implemented by a computing apparatus 202 that implements a generating a CBCABM for predicting an optimal electronic document sending time. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for generating a CBCABM for predicting an optimal electronic document sending time.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

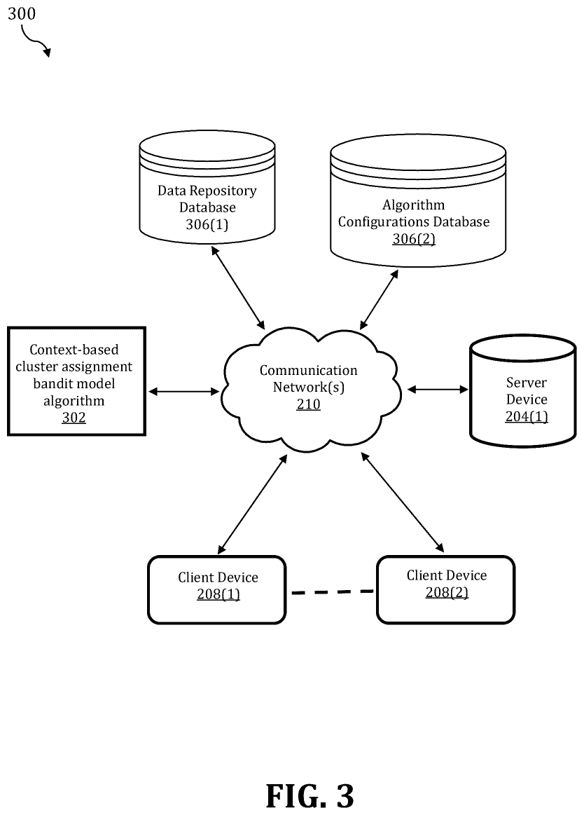

The computing apparatus 202 may be described and illustrated in FIG. 3 as may include a Contextual-Based Cluster Assignment Bandit (CBCABM) Reinforcement Learning (RL) algorithm 302, although it may include other rules, algorithms, policies, modules, databases, or applications, for example. As will be described below, the CBCABM RL algorithm 302 may be configured to implement method of generating a CBCABM for predicting an optimal electronic document sending time.

FIG. 3 illustrates a diagram of a system environment 300 for implementing method of generating a CBCABM for predicting an optimal electronic document sending time by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The CBCABM RL algorithm 302 may be configured to access these databases for implementing the method of generating a CBCABM for predicting an optimal electronic document sending time.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

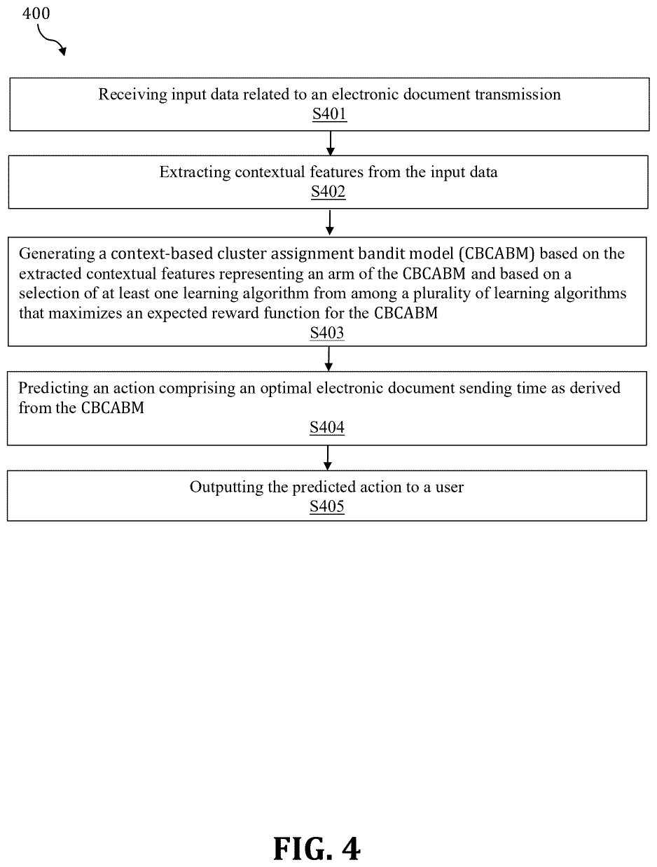

The CBCABM RL algorithm 302 may execute a process implementing method of generating a CBCABM for predicting an optimal electronic document sending time. The process for generating a CBCABM for predicting an optimal electronic document sending time may be generally indicated at flowchart 400 in FIG. 4.

FIG. 4 illustrates a flowchart of a process diagram 400 of a process for generating a CBCABM for predicting an optimal electronic document sending time according to an embodiment. The process diagram 400 may be implemented by the system environment 300 of FIG. 3, a network environment 200 of FIG. 2, and the system 100 of FIG. 1.

At step S401 of the flowchart process 400, the computing apparatus 202 may receive input data related to an electronic document transmission. The input data may include a user metric, a document attribute, and a historical interaction data. The user metric may include a user demographic and a user identification. The document attribute may include a document type and an urgency identifier. Additional attributes may include number documents to be signed and a completion status for the electronic document. The historical interaction data may include at least one from among a historical sending time, a past action, and a past outcome.

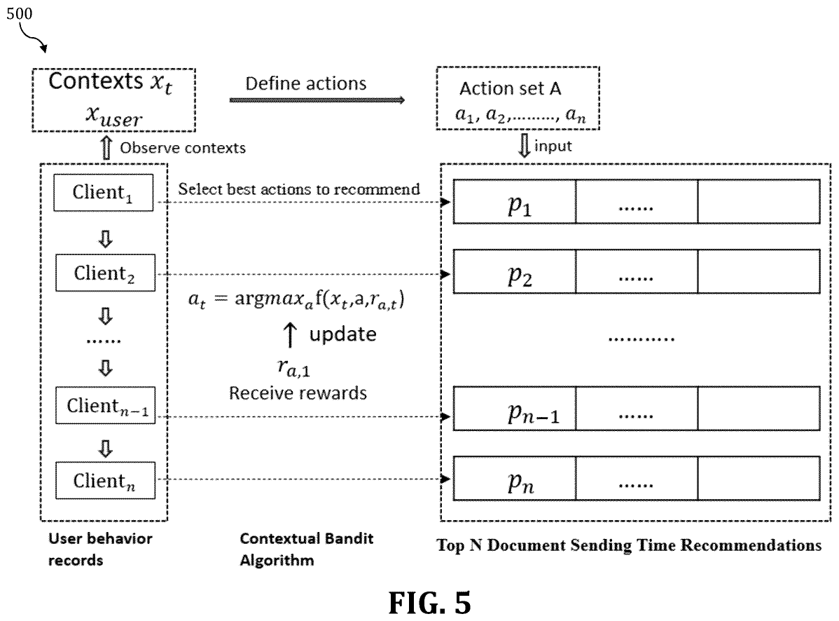

At step S402 of the flowchart process 400, the computing apparatus 202 may extract contextual features from the input data. See FIG. 5 for further details. The data may be extracted by using an electronic data integration and analytics platform with data loading capabilities or by using built-in connectors.

At step S403 of the flowchart process 400, the computing apparatus 202 may generate a contextual-based cluster assignment bandit model (CBCABM) based on the extracted contextual features representing an arm of the CBCABM and based on a selection of at least one learning algorithm from among a plurality of learning algorithms that maximizes an expected reward function for the CBCABM. The CBCABM may be a RL model.

Continuing with step S403, the plurality of learning algorithms may include a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHN) learning algorithm, a cluster learning algorithm, a radius neighborhood learning algorithm, and a tree bandit learning algorithm. Additionally, the process at step S403 may also include techniques for reward estimation based on a past arm selection, a randomized technique for arm ranking, and an ensembling technique for breaking user contexts down into individual ranges for bandit optimization. The expected reward function (e.g., an arm index) may include an argmax function with an estimated reward term representing an exploitation concept and a confidence interval representing an exploration concept.

Continuing with step S403, the CBCABM may be generated by training the CBCABM based on the historical interaction data to estimate a reward associated with the predicted action that maximizes the expected reward function. A feedback loop mechanism may also performed as part of the training of the CBCABM. The feedback loop mechanism may be based on at least one from among a user feedback, a performance evaluation of the CBCABM, and a changing need of a business organization that utilizes the CBCABM. Performing the feedback loop may include performing an evaluation of the CBCABM based on a predetermined evaluation framework with a predetermined performance threshold metric based on a mean and a standard deviation of a rewards distribution.

Continuing with step S403, the process may further include performing an unsupervised learning to define a cluster assignment based on the input data as described above. The process may further define a selection of an arms or arms according to a ranking of rewards within each cluster, such that the arm with maximum estimated reward is pulled most often at the end of training.

Additionally, the process may further include updating the CBCABM by fine-tuning hyperparameters of the CBCABM in conjunction with an updating rule associated with the selected at least one learning algorithm as part of the training process of the CBCABM. The updating rule may include at least one from among a gradient descent function, a distance measurement function, a cosine similarity function, and a probability function. The updating rule may also include a ranking function or a cluster assignment,

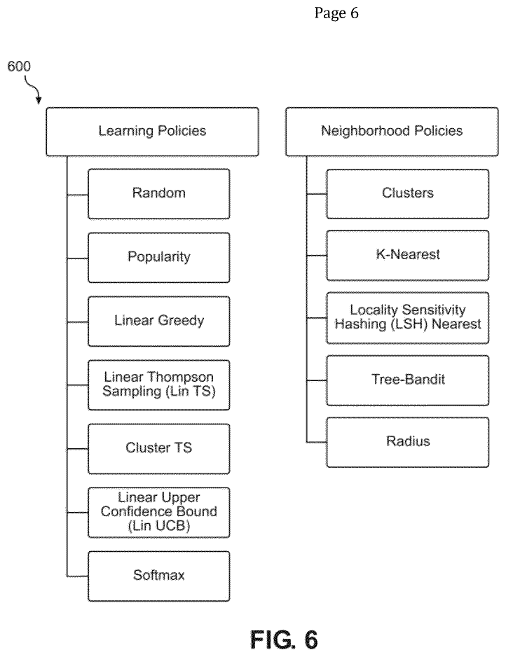

Furthermore, in conjunction the previously described processes, the generation of the CBCABM may also include optimizing an epsilon-greedy algorithm based on adjusting an epsilon value to provide a balance between an exploitation concept and an exploration concept associated with a performance of the CBCABM. These various processes related to step S403 are further described FIGS. 5 and 6.

At step S404 of the flowchart process 400, the computing apparatus 202 may predict an action comprising an optimal electronic document sending time as derived from the CBCABM. See FIGS. 5 and 6 for further details. At step S405 of the flowchart process 400, the computing apparatus 202 may output the predicted action to a user. For instance, the output of the predicted action may be provided to the user via a display interface.

FIG. 5 illustrates an example overview process 500 for generating a CBCABM for predicting an optimal electronic document sending time according to an embodiment as described in FIG. 4 at steps S401-S405.

The example overview process 500 (or process 500 for short) provides a mechanism involving a CBCABM to enhance the user experience, increase user engagement, and optimize document-related operational and system workflows through generating a CBCABM for predicting an optimal electronic document sending time.

The objectives associated with the process 500 may include, but are not limited to: user engagement, workflow optimization, user adoption, customization, user education, performance metrics, data security and compliance, adaptability, feedback loop, and integration. These objectives are subsequent described below.

The objective of user engagement may include improving user engagement by providing personalized and relevant recommendations within the electronic document signing platform. This can include suggesting features, tools, or actions based on the user's historical interactions and preferences. The objective of workflow optimization may include enhancing document workflow efficiency by recommending optimal sequences of actions or suggesting automation features that align with the user's specific needs and document types. The objective of user adoption may include encouraging the adoption of new electronic document signing features by intelligently recommending them to users based on the users' usage patterns, industry standards, and the evolving landscape of digital document processes. The objective of customization may include enabling a high level of customization in recommendations to cater to diverse user needs. This may involve adapting the CBCABM to different document types, industries, or compliance standards.

The objective of user education may include supporting user education by suggesting relevant tutorials, guides, or help resources based on the user's interactions and potential areas of improvement in utilizing the electronic document signing platform effectively. The objective of performance metrics may include establishing key performance metrics, (e.g., increased user satisfaction, reduced time in electronic document processing, or improved completion rates) to measure the success of the CBCABM and guide iterative improvements to the CBCABM based on these performance metrics. The objective of data security and compliance may include ensuring that the recommendation model adheres to strict data security and compliance standards, especially when dealing with sensitive information in electronic documents, to maintain user trust and meet regulatory requirements.

The objective of adaptability may include designing the CBCABM to be adaptable to changing user behaviors, industry trends, and technological advancements to ensure its relevance and effectiveness over time. The objective of a feedback loop may include implementing a feedback mechanism to continuously improve the CBCABM based on user feedback, evolving business needs, and emerging technologies. The objective of integration may include facilitating a seamless integration of the CBCABM into the electronic document signing platform, ensuring that the CBCABM complements existing features and contributes positively to the overall user experience without causing disruptions.

These objectives collectively aim to create a CBCABM that enhances the user experience within the electronic document signing ecosystem, making electronic document-related processes more intuitive, efficient, and tailored to individual user needs.

Therefore, the explainability of the CBCABM is necessary in meeting regulatory expectations, mitigating the risk of bias, and aligning with user expectations. From a regulatory standpoint, transparency and interpretability are crucial elements to ensure compliance with data protection and fairness standards. Providing clear explanations for the CBCABM's decisions helps meet the requirements of various regulations and demonstrates a commitment to ethical and accountable artificial intelligence (AI) practices. Moreover, addressing the risk of bias is imperative to uphold fairness and prevent unintended discrimination. As such, the CBCABM needs to be designed with transparency measures that expose and rectify biases, fostering a more equitable decision-making process. Simultaneously, meeting user expectations requires understandable and coherent recommendations. Users should be able to comprehend why a particular suggestion is made, instilling trust in the model's outputs. Striking a balance between these considerations ensures the responsible and effective deployment of the CBCABM in a way that aligns with regulatory, ethical, and user-driven expectations.

The process 500 may show a CBCABM (which may also be denoted as the contextual bandit algorithm). The CBCABM may receive input data related to an electronic document transmission, which may include a data action set (e.g., action set A) and user behavior records at a plurality of time points as denoted by t associated with data items for users (or clients, wherein the terms may be used interchangeably) from 1 to N related to the user behavior. Contextual feature data (contexts xₜ) for a user x may be derived from the user behavior records, which may then be used to define user actions and derive the action set A. The CBCABM may generate a prediction (p) of top N electronic document signing recommendation times by selecting an optimal (i.e., best) action to recommend. This may be done by generating the CBCABM and implementing the CBCABM within the electronic document signing platform. Doing so may offer several key benefits that can significantly enhance the platform's user experience and overall efficiency.

For instance, the CBCABM may be a type of machine learning algorithm. Notably, the CBCABM may be a reinforcement learning (RL) algorithm that takes into account the context feature and/or user-specific information when making decisions.

Indeed, the advantages of using a CBCABM for generating predictions for electronic document signing times as part of the electronic signing platform has already been introduced above as part of the various objectives. These advantages may include technological advantages and are further expanded upon below.

The advantages of personalized recommendations using CBCABM may lie in their ability to excel at providing personalized recommendations by considering individual user contexts. In the case of electronic document signing, this would mean tailoring suggestions for electronic document signature workflows based on a user's historical interactions, preferences, and the specific characteristics of the documents they are working with. This personalization leads to more relevant and useful recommendations, ultimately improving user satisfaction.

The advantages of using the CBCABM may also include an adaptability to changing user behavior. The users of an electronic document signing platform may exhibit diverse behaviors and preferences over time. As such, the CBCABM may continuously adapt to these changes by learning from ongoing user interactions. This adaptability ensures that the generated predictions of recommended actions (e.g., predicted action regarding an optimal electronic document sending time) remains relevant as user needs and document types evolve. Thus, contributing to a more dynamic and responsive user experience.

The advantages of using the CBCABM may also include technological advantages related to optimizing system resources, i.e., system resource allocation. The CBCABM optimizes system resource allocation by focusing on delivering the most effective recommendations for each user context based on a predicted optimal timeframe for sending the electronic document for signing. The optimal timeframe is generated based on consideration of system resources (e.g., number of documents, region name, client type, entity type, network and/or bandwidth congestion data, network and/or bandwidth usage, avoiding peak system usage times, etc.) to ensure efficient system resource usage so that the electronic document can be sent during the predicted optimal timeframe. This ensures a maximum chance that the electronic document will be signed and that the electronic document is sent at a timeframe that would not burden turn time and the system resources.

Thus, for instance, this may mean suggesting the most suitable actions or features based on the specific attributes of the electronic document, the user's historical usage patterns, historical system resource usage with network and/or bandwidth data, etc. to expedite the client induction process and reduce the turn time for the electronic document. This targeted approach by the CBCABM that accounts for user data and system resources data enhances the efficiency of the CBCABM and the electronic document signing platform. Thus, improving system resource efficiency and operation in conjunction with saving users' time and streamlining the electronic document signing process.

The advantages of using the CBCABM may also include another technological advantage related to the generation and training of the CBCABM itself. The CBCABM involves a balance of between exploitation concept and exploration concept to enable the CBCABM to learn from new interactions while leveraging existing knowledge. That is, the CBCABM needs to balance between exploitation (choosing actions that are known to yield high rewards) and exploration (trying new actions to discover their rewards). This trade-off is crucial for learning an optimal operation over time.

In the context of electronic document signing, this ensures that the CBCABM can, via incorporation with the electronic document signing platform, introduce users to new features or document handling techniques (exploration concept) while still relying on proven, effective recommendations (exploitation concept) for an optimized user experience.

The advantages of using the CBCABM may also include quick learning and adaptation. The CBCABM can learn and adapt quickly, making it well-suited for dynamic environments. As users interact with electronic document, the CBCABM can rapidly incorporate this feedback to refine its recommendations. This agility is crucial in a fast-paced digital document management landscape where user's needs and preferences may change rapidly.

Thus, integrating the CBCABM in an electronic document signing platform provides enhanced personalization, adaptability, optimized resource allocation, and a balance between exploration and exploitation. These advantages collectively contribute to an improved user experience, increased efficiency in electronic document workflows, and optimization of system resources.

Continuing with FIG. 5, the CBCABM involves a contextual bandit problem. In a contextual bandit problem, there may be a setting where at a time step i: the CBCABM may observe a random state (sometimes also called ‘query’ or ‘context’), Xᵢ. In the recommendation setting, Xᵢ can be the list of times an electronic document is signed by a client. The variables, Xᵢ are assumed independent and identically distributed.

Furthermore, at the time step i, the CBCABM may select an action Aᵢ for an envelope identification (ID). Here, A may be the recommendation provided to the signer of the electronic document. The envelope ID may denote electronic document envelope features such an entity type, region, etc.

Furthermore, at the time step i, the CBCABM may then receive a reward Rᵢ. Here, the reward is a continuous reward that may be a hyperbolic tangent function ranging between 0 to 1, with the reward being 0 if the document is not signed on time, and non-zero otherwise. The median of all the electronic documents' signing time may be computed to and assigned a value of 1 if the electronic document is signed within the median timeframe because the goal is to get the electronic document signed as soon as possible. The reward Rᵢ may be assumed to depend only on the context and action, Xᵢ and Aᵢ at the same time step.

It may be assumed at the time step i for the CBCABM that there might not be dependency between the contexts (or states) at different time steps, whereas in traditional RL algorithm, the variable Xᵢ could depend on the previous state, Xᵢ₋₁ and action, Aᵢ₋₁. In other words, the CBCABM may be a simplified version of RL algorithm, where “episodes” may just be of length l.

That is, contextual bandit model may represent a sequential decision-making framework where, at each time step t, an agent/model (such as the CBCABM) observes a context xₜ∈X (a feature vector representing the state of the environment), selects an action aₜ∈A from a finite set of actions, and receives a stochastic reward rₜ(aₜ)∈R associated with the chosen action. The goal is to learn a policy π:X→A that maximizes the cumulative reward over time.

In an electronic document signing time recommendation problem, the reward rₜ(aₜ) could be a binary outcome indicating whether a user signed a document at the recommended time (e.g., 1 for success, 0 for failure), the context xₜ may include user-specific features such as historical signing times, geographic location, device type, and day of the week, and the action aₜ may represent the specific time slot recommended for sending the document (e.g., 9:00 AM, 2:00 PM, etc.).

To reduce this contextual bandit problem to a non-contextual bandit problem using unsupervised learning, clustering may used utilized to group similar contexts into clusters, effectively discretizing the context space.

For example, let C={C₁, C₂, . . . , C_{K}} denote a set of K clusters obtained by applying an unsupervised clustering algorithm (e.g., k-means) to the context data

$${\{ {x}_{\text{?}} \}}_{\text{?} 1}^{T} .$$

$$\text{?} \text{indicates text missing or illegible when filed}$$

Each cluster Cₖ may represent a subset of contexts that are similar in feature space. Mathematically, the clustering can be expressed as Cₖ={xₜ:|xₜ−μₖ∥₂≤∥xₜ−μⱼ∥₂∀j≠k}, where μₖ is the centroid of cluster Cₖ. Once the contexts are clustered, the problem reduces to a non-contextual bandit problem within each cluster, wherein the agent/model learns a separate policy πₖ:A→ [symbol] for each cluster Cₖ.

The reward for action aₜ in cluster Cₖ is represented as rₜ(aₜ)~Pₖ(⋅|aₜ), where Pₖ is the reward distribution for cluster k. The agent/model can then use a standard multi-armed bandit algorithm (e.g., UCB or Thompson sampling) to learn the optimal action for each cluster, effectively decoupling the context from the decision-making process while still leveraging the structure discovered through clustering. This approach reduces complexity by focusing on cluster-level policies rather than context-specific policies, while still capturing meaningful patterns in the data.

In the CBCABM, for the electronic document signing time recommendation problem, several key assumptions may be made to ensure the CBCABM is both theoretically grounded and practically effective.

First, it may be assumed that the context space X (e.g., user features such as historical signing times, device type, geographic location, day of the week, etc.) can be partitioned into clusters C={C₁, C₂, . . . , C_{K}} using a clustering algorithm (e.g., k-means or Gaussian Mixture Models). Each cluster Cₖ represents a group of users with similar context features, and it may be assumed that users within the same cluster share similar preferences for electronic document signing times. This implies that the optimal action (recommended time) is consistent within each cluster, allowing the CBCABM to learn cluster-specific policies.

Second, it may be assumed that the reward function rₜ(aₜ) (e.g., whether a user signs an electronic document at the recommended time) follows a logistic model conditioned on the cluster assignment. Specifically, for a given cluster Cₖ, the probability of a positive reward (successful signing) for action aₜ is modeled as

$$P ( {r}_{t} ( {a}_{t} ) = 1 \vert {C}_{\text{?}} ) = σ ( {θ}_{\text{?}}^{T} ϕ ( \text{?} ) ) ,$$

$$\text{?} \text{indicates text missing or illegible when filed}$$

where σ(⋅) is the logistic function, θₖ is a cluster-specific parameter vector, and φ(aₜ) is a feature representation of the action aₜ. This assumption captures the non-linear relationship between actions and rewards within each cluster and allows the CBCABM to estimate the probability of success for each recommended time.

Third, it may be assumed that the cluster assignments are static or change slowly over time, denoting that a user's cluster membership remains relatively stable during the learning process. This allows the CBCABM to focus on learning the cluster-specific parameters θₖ without needing to frequently reassign users to clusters.

Fourth, it may be assumed that the context features are informative and sufficient to capture the variability in user behavior. This implies that the clustering algorithm can effectively group users based on their context, and that the resulting clusters are meaningful for the recommendation task.

Lastly, it may be assumed that the exploration-exploitation trade-off can be managed effectively using a bandit algorithm (e.g., Thompson sampling or UCB) within the logistic framework. This involves maintaining a posterior distribution over the cluster-specific parameters θₖ and updating it based on observed rewards, allowing the CBCABM to balance exploration of uncertain actions with exploitation of known high-reward actions.

Taken together, these assumptions collectively enable the CBCABM to provide personalized and adaptive time recommendations for users of electronic document signing applications by leveraging the structure of the context space while maintaining computational efficiency.

Furthermore, in applying an unsupervised learning algorithm to the electronic document signing time recommendation problem, several other key assumptions may be made to ensure that the approach is both theoretically sound and practically feasible.

First, it may be assumed that the context space X (e.g., user features such as historical signing times, device type, geographic location, day of the week, etc.) contains meaningful structure that can be captured by clustering. This implies that users with similar contexts exhibit similar signing behaviors, allowing the algorithm to group them into clusters where the optimal action (recommended time) is consistent within each cluster.

Second, it may be assumed that the reward function rₜ(aₜ) (e.g., whether a user signs an electronic document at the recommended time) may be conditionally independent of the context given the cluster assignment. In other words, once contexts are grouped into clusters, the reward distribution for a given action may depend only on the cluster and not on the specific context within the cluster. This assumption enables the reduction of the contextual bandit problem to a non-contextual one within each cluster.

Third, it may be assumed that the clustering algorithm (e.g., k-means) can effectively partition the context space into clusters that are both interpretable and actionable. This requires that the distance metric used in clustering (e.g., Euclidean distance) is appropriate for the context features and that the number of clusters K is chosen judiciously, either through domain knowledge or methods like the elbow method or silhouette score.

Fourth, it may be assumed that the reward distributions Pₖ(⋅|aₜ) for each cluster Cₖ are stationary over time, denoting that the relationship between actions and rewards does not change significantly within the time frame of the learning process. This stationarity assumption may be critical for the convergence of the bandit algorithm within each cluster.

Lastly, it may be assumed that the exploration-exploitation trade-off can be managed effectively within each cluster using standard multi-armed bandit algorithms (e.g., UCB or Thompson sampling). This implies that the agent/model has sufficient opportunities to explore different actions within each cluster to learn the optimal policy without incurring excessive regret.

Taken together, these assumptions collectively enable the unsupervised learning algorithm to reduce the complexity of the contextual bandit problem while still capturing the underlying structure of the data, making it a practical and scalable solution for the electronic document signing time recommendation problem.

Continuing with FIG. 5, the CBCABM may involve a policy, such as an algorithm, whereby the terms may be used interchangeably in this application. A policy π may represent a mathematical object which describes how the recommendation may be chosen when a context x is known. The policy can be either stochastic or deterministic. If deterministic, then it may be defined by a simple one-to-one mapping x→a that associates to each state x the recommended action a. That is, the timing of sending the electronic document for signing. More generally, the policy can be stochastic: at each possible state x, a probability distribution may be associated on the set of actions. It is thus noted that for a policy π, the term π(a, x) may denote the probability of choosing action a when in a state x.

The expected reward following a policy can be computed when training the CBCABM. When training the CBCABM, the goal is to find the policy which maximizes the expected reward (E_{X}) using an argmax function (see example argmax function below).

$$\hat{π} = Arg {max}_{π} {E}_{X} ( {E}_{A ∼ π} ( R \vert A = a , X = x ) ) )$$

While optimal policy may usually be deterministic, it may be more likely that a fully deterministic policy is not chosen because it does not account for the exploration concept. That is, in each context, an action that maximizes the expected reward may be chosen. However, a fully deterministic policy would not include consideration of the exploration concept. As such, a randomized learning algorithm can be utilized to keep some exploration on the different actions, and this is useful to learn how to improve the learning algorithm as a baseline model.

As such, the generation of the CBCABM may be based on selection of at least one learning algorithm from among a plurality of learning algorithms that maximizes an expected reward function for the CBCABM. The example learning policies are previously described and further expanded upon below in FIG. 6.

The CBCABM, which includes RL, may enable the electronic document signing platform's time modeling element to dynamically adapt its behavior based on contextual cues, such as user preferences and document characteristics. By leveraging epsilon-greedy exploration strategies, the CBCABM can balance the exploration of new options (epsilon ϵ) with exploiting present effective strategies, ensuring continual improvement in performance.

That is, by optimizing the time modeling functionality within electronic document signing platform through the implementation of the CBCABM, which includes RL, coupled with strategic tuning of hyperparameters such as epsilon ϵ, number of clusters, and tau τ, presents a sophisticated approach to enhancing user experience and operational system efficiency.

The selection of the number of clusters can be important in organizing contextual information efficiently. Through clustering, similar contexts can be grouped together, allowing the CBCABM to generalize learning across related scenarios. Optimal clustering facilitates effective decision-making, striking a balance between the CBCABM's complexity and accuracy.

Additionally, the hyperparameter tau τ, pertaining specifically to a softmax algorithm and governing the degree of exploration concept versus exploitation concept, plays a crucial role in fine-tuning the CBCABM's responsiveness to new information. By adjusting tau τ, the electronic document signing platform with the CBCABM can regulate the extent to which exploring new actions may be prioritized versus exploiting known high-reward actions, thereby optimizing performance over time.

In essence, the integration of the CBCABM with carefully calibrated hyperparameters enables the time modeling element the CBCABM and the CBCABM to continually learn and adapt, ensuring efficient electronic document processing and a seamless user experience. Through iterative refinement guided by hyperparameter tuning, the electronic document signing platform with the CBCABM can deliver tailored solutions that align closely with the user's needs and preferences, thereby maximizing utility and operational system efficiency.

The CBCABM can be fine-tuned by incorporating hyperparameters such as L1 and L2 regularization, which pertain specifically to the LSHN algorithm, wherein the optimization scheme aims to fine-tune the CBCABM learning process, effectively balancing exploration and exploitation strategies. Through CBCABM, the electronic document signing platform may adaptively learn from past interactions and dynamically adjust its decision-making process based on the contextual information available at each step. The inclusion of L1 and L2 regularization further enhances the CBCABM's robustness by penalizing overly complex or noisy features, thus promoting a more generalizable and stable learning process in the LSHN algorithm. This optimization scheme not only streamlines the time modeling process within electronic document signing platform, but also fosters continuous improvement by iteratively refining decision-making strategies in response to evolving contextual cues and user feedback.

The performance of the CBCABM can be evaluated based on various metrics that assess the effectiveness of the CBCABM. One metric may be area under the curve (AUC), which measures the CBCABM's ability to distinguish between positive and negative instances. Another metric precision may focus on the accuracy of positive predictions, emphasizing the relevance of selected actions. Another metric may be recall, which gauges the CBCABM's ability to identify all relevant instances, emphasizing completeness. Another metric may be normalized discounted cumulative gain (NDCG) may assess the ranking quality of the selected actions, considering their positions. Another metric may be mean average precision (MAP) that calculates the average precision across different recall levels, providing a comprehensive evaluation. These metrics may collectively offer a nuanced understanding of how well the CBCABM is performing in terms of discrimination, relevance, ranking, and precision-recall trade-offs.

For instance, a recall metric such as recall@10 can be computed. The recall@10 may represent a top 10 recommendation associated with sending the electronic document. The recall@10 may be a reasonable and blunt metric for comparing the different learning algorithms that may be utilized in the CBCABM. However, the individual learning algorithms may also be compared at a more fine-grained level by considering whether they put the relevant recommendation times closer to the top of the sort. This fine-grained comparison may be performed by plotting recall@1 through N, which can reveal positional differences for visual inspection.

The evaluation metrics may be plotted using x-y axis displays, wherein each line on the plot may represent different learning algorithms and display the value (y-axis) of a given metric at different top-k (x-axis) for each of the learning algorithms.

Continuing with FIG. 5, several assumptions may also be utilized in generating the CBCABM. The CBCABM may utilize binary rewards and make various assumptions that simplify the learning problem and thus, enable efficient exploration and exploitation in a given operating system environment. One assumption may be regarding the contextual information, notably that the operating system environment provides contextual information or features that describe the current state. These contextual features enable the CBCABM to make decisions by capturing relevant information about the context in which an action is taken.

Another assumption may be related to stationarity, i.e., that the underlying dynamics of the operating system environment does not change over time unless additional features are added. In other words, the relationships between contextual features and rewards remain constant during the learning process of the CBCABM.

Another assumption may be that the CBCABM exhibits Markovian property. That is, the CBCABM may assume a Markovian property, implying that the current state contains all the information necessary to make decisions and the future state depends only on the current state and action, not on the sequence of previous states and actions.

Another assumption may be that the CBCABM has continuous rewards represented by a hyperbolic tangent function. That is, the rewards may range between 0 and 1. This can optimize the learning problem and may enable a maximization of a specific outcome or success criterion.

Another assumption may be that there are no delayed rewards. Thus, the CBCABM may assume that rewards are received immediately after taking an action, and there is not a delayed or deferred reward. This simplifies the learning process by avoiding complications associated with delayed reinforcement.

Another assumption may be related to a known action set, wherein the CBCABM may assume that there are a known set of available actions at each decision point. The CBCABM may enable a selection of actions from this fixed set based on the observed context and past experiences.

Another assumption may be related to an independence of observations, wherein the observations, contextual features, and rewards may be assumed to be independent across different time steps. This assumption simplifies the learning process and allows for the use of standard statistical techniques.

Another assumption may be related to context-action independence. The CBCABM may assume that the context and action are conditionally independent given the parameters of the CBCABM. This may imply that the impact of the context on the reward may be captured independently of the chosen action.

Another assumption may be in contextual learning ability. That is, the CBCABM may assume the ability to generalize from observed contexts to unobserved contexts. This can be essential for making good predictions and decisions in situations not encountered during the training phase.

Continuing with FIG. 5 and the generation of the CBCABM, the predictive performance of the CBCABM may be enhance through conservationism to ensure that the predicted recommendations are accurate. Thus, by incorporating conservatism into the CBCABM outputs, it can enable a balance between exploration concept and exploitation concept while still prioritizing precision, recall, MAP, and NDCG metrics.

For example, by emphasizing precision as part of conservationism, this can ensure that the recommended electronic document sending times are highly relevant to the user's needs and context. This helps to minimize the risk of suggesting irrelevant or inappropriate times, which is particularly crucial in sensitive electronic document management scenarios such as those encountered in electronic document signing.

Additionally, a focus on recall as part of conservationism ensures that the CBCABM does not overlook potentially valuable electronic documents that may be relevant to the user but could be overlooked by overly conservative aspects. Thus, by maintaining a balance between precision and recall, a comprehensive coverage of relevant electronic documents can be provided by the CBCABM while avoiding unnecessary recommendations.

Furthermore, incorporating MAP and NDCG metrics would enable an evaluation of the overall quality of recommendations by considering the rank and relevance of suggested electronic documents. By optimizing these metrics, it can be ensured that the recommended electronic document sending times and their corresponding electronic documents being sent are not only relevant but also presented in an order that maximizes user satisfaction and utility.

Substantiating of the conservatism of the CBCABM outputs may involve comparing the metrics above between recent data and data which can be, e.g., but not limited to, 6 months old, and establishing that the data at both timeframes show similar trends. Thus, demonstrating that these conservationism approaches help in quantifying and managing the uncertainty associated with the CBCABM's recommendation decisions and how these metrics can differ using fewer features.

Therefore, as described above, enhancing recommendation performance through conservative outputs of the CBCABM for electronic document signing times recommendations may involve prioritizing precision, recall, MAP, and NDCG metrics while incorporating techniques to ensure the reliability of the recommendations provided. By striking a balance between exploration and exploitation and emphasizing the relevance and quality of recommended electronic document sending times, the user experience and utility of electronic document signing platform can be efficiently enhanced.

FIG. 6 illustrates an example 600 of various policies/algorithms (the terms may be used interchangeably) according to an embodiment as described in FIG. 4 at steps S403-S405. The example policies may include various algorithms including learning and neighborhood algorithms. The learning algorithms may include, but are not limited to: random, popularity, linear greedy, linear Thompson sampling, cluster Thompson sampling, linear upper confidence bound, and softmax. The neighborhood algorithms may include, but are not limited to: clusters, K-nearest neighbor (KNN), locality sensitivity hashing nearest (LSHN), tree-bandit, and radius.

The CBCABM is a multi-armed bandit model, which involves reinforcement learning. In general, an arm may be an action or strategy that an agent/model can choose for each decision point. A bandit may be a group of actions or strategies. In the present application, the actions or strategies are related to an electronic document sending time. In general, a “pull” or play or trial may represent a chance to test the idea or strategy. In general, the reward may represent a unit of success that is measured after each “pull” or play or trial. In general, the regret may represent a performance metric.

The random and popularity algorithms may be denoted as a randomized popularity learning algorithm. This algorithm may return a randomized popular arm for each prediction. The probability of selection for each arm may be weighted by its mean reward. An assumption may be made that the rewards are non-negative. The probability of selection may be calculated as shown below, wherein μᵢ is the mean reward for that arm i.

$$P ( arm ) = \frac{{μ}_{i}}{\sum μ}$$

The linear upper confidence bound algorithm may balance exploration concept and exploitation concept of the CBCABM by enabling a selection of an action (e.g., electronic document signing time recommendation) with the highest estimated reward (e.g., click-through rate) based on linear models. In each round, the context vector Xₐ of each arm a∈ [symbol] of the CBCABM may be observed. An arm of the CBCABM may be selected. Then, a corresponding reward r_{at,u}. The CBCABM may then be updated based on the selected. The term Cₜ(a) may represent a confidence interval associated with exploration concept. The term [symbol] may represent an estimated reward associated with exploitation concept. The combined terms [symbol] +Cₜ(a) may represent an upper confidence bound.

$${a}_{t} = arg {max}_{a} ( {\hat{r}}_{a , t} + {C}_{t} ( a ) )$$

The softmax learning algorithm may select each arm with a probability proportionate to its average reward. The average reward may be calculated as a logistic function with each probability as shown below, wherein μᵢ may be the mean reward for that arm and τ may be the “temperature” to determine the degree of exploration.

$$P ( arm ) = \frac{{e}^{\frac{{μ}_{i} - max μ}{τ}}}{\sum {e}^{\frac{μ - max μ}{τ}}}$$

The Thompson sampling learning algorithm may create a beta distribution for each arm, and then randomly samples from these distributions. The arm with the highest sample value may be selected (as shown below). Note that rewards must be binary to create beta distributions. Hence, the initial rewards are 0 and 1. The term Γ is the gamma function. The terms α and β are shape parameters. The term μᵢ is the mean reward for arm, i. The term P(arm) is a power function of the variable, μᵢ, and of its reflection, (1−μᵢ)

$$P ( arm ) = \frac{Γ ( {α}_{i} + {β}_{i} )}{Γ ( {α}_{i} ) Γ ( {β}_{i} )} {{μ}_{i}^{{α}_{i} - 1} ( 1 - {μ}_{i} )}^{{β}_{i} - 1}$$

Turning now to the neighborhood-type learning algorithms. It is noted that the terms learning algorithm and algorithm may be used interchangeably in this application. The locality-sensitive hashing approximate nearest neighbors (LSHN) algorithm may be a nearest neighbor approach that uses locality sensitive hashing function, h, with a simhash to select observations to be used with a learning algorithm. The similarity, sim(x, y) of two points (contexts), x and y, may be the cosine of the angle between them. That is, the cosine distance may be represented as sim(x, y)=cos θ^{x·y}. The LSHN algorithm may be shown below.

$$P [ h ( x ) = h ( y ) ] \geq p 1 if sim ( x , y ) \geq {S}_{0} and$$

$$P [ h ( x ) = h ( y ) ] \leq p 2 if sim ( x , y ) \leq {cS}_{0}$$

$$Such that c < 1 and {p}_{2} < {p}_{1}$$

Continuing with the LSHN algorithm, the concept of close together may be within the context of the similarity metric. In this case, electronic documents may be considered as close together when the angle between them the two points x and y representing the two electronic documents are small. The smaller the angle between the two points, the closer the two electronic documents are to each other. Hence, contexts that are close together will have, with high probability, the same value. Conversely, contexts that are far apart will have a different value.

Continuing with the LSHN algorithm, for the simhash, this may be achieved by dividing the space with hyperplanes. Contexts may be projected as points onto a hyperplane of n_{contexts}_{_{cols}}×n_{dimensions} and each column of the hyperplane may be evaluated for its sign, giving an ordered array of binary values. This may then be converted to a base 10 integer used as the hash code to assign the context to a hash table. This process may be repeated for a specified number of hash tables, wherein each has a unique, randomly-generated hyperplane. To select the neighbors for a context, the hash code may be calculated for each hash table and any contexts with the same hashes are selected as the neighbors.

As with the radius or k value for other nearest neighbors algorithms, selecting the best number of dimensions and tables requires tuning. For the dimensions, a good starting point may be to use the log of the square root of the number of rows in the training data. This will give sqrt(n_rows) number of hashes.

The number of dimensions and number of tables have inverse effects from each other on the number of empty neighborhoods and average neighborhood size. Increasing the dimensionality decreases the number of collisions, which increases the precision of the approximate neighborhood but also potentially increases the number of empty neighborhoods. Increasing the number of hash tables increases the likelihood of capturing neighbors the other random hyperplanes miss and increases the average neighborhood size. It should be noted that the fit operation is O(2**n_dimensions).

The tree-bandit algorithm may fit a decision tree for each arm using context history. It uses the leaves of these trees to partition the context space into regions and keeps a list of rewards for each leaf. To make a prediction, the tree-bandit algorithm may receive a context vector and go to the corresponding leaf at each arm's tree and apply the given context-free multi-armed bandit (MAB) learning policy to predict expectations and choose an arm. The tree-bandit neighborhood algorithm may be compatible with the following context-free learning algorithm only: epsilon greedy, Thompson sampling, and linear upper confidence bound interval. The tree-bandit algorithm may be a neighborhood-type learning algorithms that may be a modified version of the tree heuristic algorithm which uses decision tree learners to model the context-reward distribution for each action. To navigate the exploration-exploitation tradeoff, a parameter free bootstrapping technique that emulates the core principle behind Thompson sampling may be utilized as part of the tree-bandit algorithm.

The radius algorithm may be a nearest neighborhood approach that selects the observations within a given radius to be used with a learning policy.

The clusters neighborhood algorithm may be a k-means clustering approach that uses the observations from the closest cluster with a learning policy.

The KNN algorithm may be a nearest neighbors approach that selects the k-nearest observations to be used with a learning policy. The KNN algorithm may be shown below.

$${a}_{1} = arg {max}_{{x}_{t}} f ( {x}_{t} , {x}_{c} , a , r ) where r = tanh ( 1 - \frac{\vert {x}_{t} - {x}_{c} \vert}{median} ) + 1$$

Continuing with the KNN algorithm, using (arg maxₓₜ), the context assignment (xₜ) that maximizes a reward function (R(xₜ, x_{c})) can be sought. The term ƒ(xₜ,x_{c}) may evaluate the quality of the context assignment to the cluster centroid ((x_{c}). To

To mathematically define a separate bandit policy and reward sequence for each within-cluster model, a multi-armed bandit framework may be considered wherein each arm corresponds to a model associated with a specific cluster. The goal may be to learn a policy that selects the optimal model (or arm) based on observed rewards.

This goal may be formulated in an example process as described subsequently. Definitions cluster and models: an assumption may be made that there are K clusters, each associated with a model (Mₖ) for k=1, 2, . . . , K. Context and actions: let xₜ be the context at time (t) and aₜ be the action taken that corresponds to selecting a model (Mₖ). Reward function: the reward (rₜ) observed at time (t) when model (Mₖ) is active may be represented as shown below.

$$[ {r}_{t} = tanh ( 1 - \frac{\vert {x}_{t} - {x}_{{c}_{k}} \vert}{mediank} ) + 1 ]$$

The term xcₖ may denote the centroid of the cluster k, and medianₖ may denote a scaling factor specific to cluster k.

The description regarding the example process for formulating the goal continues subsequently. Bandit policy: the bandit policy (π) is a mapping from contexts to actions, determining which model to activate based on the current context. The policy aims to maximize the expected cumulative reward over time. Reward sequence: The reward sequence for each model Mₖ may be observed as follows: at each time step (t), the policy (π) may select an action (aₜ) based on the current context (xₜ). If (aₜ=k), then model Mₖ is active, and the reward (rₜ) is observed. The sequence of rewards for model Mₖ may be represented as rₜ: aₜ=k). Objective: the objective is to learn a policy (π) that maximizes the expected cumulative reward as shown below, wherein T is the time horizon.

$$[ {max}_{π} 𝔼 [ {\sum }_{t = 1}^{T} {r}_{t} \vert π ] ]$$

Learning the Policy: to learn the policy, learning algorithms can be used. Examples of such as learning algorithms may be, but are not limited to: epsilon-greedy, Thompson sampling, or upper confidence bound (such as linear upper confidence bound). These learning algorithms are previously described above. Notably, epsilon-greedy may enable random exploration with probability (ε) and exploit the best-known model with probability (1−ϵ). Thompson sampling relates to using Bayesian inference to sample from the posterior distribution of rewards and select the model with the highest sampled reward. Upper confidence bound (UCB) may select the model with the highest UCB on the estimated reward. Each of these algorithms maintain separate estimates of the expected reward for each model, updating these estimates based on the observed reward sequence. The hyperparameters of these algorithms, such as (ϵ) in epsilon-greedy or the confidence level in UCB, can be tuned to optimize performance.

The cluster-specific contextual bandit algorithms with equations for action selection may be shown below, wherein cluster assignment serves as a sufficient statistic for context.

Each algorithm may define the action as a₁=argmaxₐ ƒ(x_{c},xₜ,a), where x_{c} is the centroid of the cluster assigned to the current context xₜ, and the reward r is represented by

$$r = tanh ( 1 - \frac{diff\_hr}{{diff\_}_{median}} ) + 1 .$$

For the popularity algorithm: the action with the highest historical count in the cluster may be chosen:

$$a = arg {max}_{a} {\underbrace{N ( {x}_{t} , a )}}_{f ( {x}_{c} , {x}_{t} , a )} .$$

The term N(xₜ, a) denotes a number of times action a was chosen in cluster xₜ.

For the random algorithm: a random action selection may be made within the cluster:

$$a = arg {max}_{a} {\underbrace{{ϵ}_{a}} , {ϵ}_{a} \sim}_{f ( {x}_{c} , {x}_{t} , a )} .$$

The random algorithm may also include a uniform (0, 1).

For the linear greedy algorithm: a greedy selection of the action may be performed with the highest linear estimate using cluster-specific parameters:

$$a = arg {max}_{a} {\underbrace{{x}_{c}^{T} {θ}_{{x}_{t} , a}}}_{f ( {x}_{c} , {x}_{t} , a )} .$$

The term θₓ_{ₜ}_{,a} represents linear parameters for action a in cluster xₜ.

For the linear Thompson sampling algorithm: parameters may be sampled from posteriors and maximized:

$$a = arg {max}_{a} {\underbrace{\tilde{{x}_{c}^{T} {θ}_{{x}_{t} , a}}}}_{f ( {x}_{c} , {x}_{t} , a )} , {\tilde{θ}}_{{x}_{t} , a} \sim 𝒩 ( {μ}_{{x}_{t} , a} , {Σ}_{{x}_{t} , a} ) .$$

For the cluster-specific Thompson sampling: sampling from cluster-action reward distributions may be performed:

$$a = arg {max}_{a} {\underbrace{{μ}_{{x}_{t} , a} + {σ}_{{x}_{t} , a} ϵ}}_{f ( {x}_{c} , {x}_{t} , a )} , ϵ \sim 𝒩 ( 0 , 1 ) , {μ}_{{x}_{t} , a} , {σ}_{{x}_{t} , a} .$$

The terms μₓ_{ₜ}_{,a} and σₓ_{ₜ}_{,a} denotes mean and standard deviation of rewards for action a in cluster xₜ.

For the linear upper confidence bound algorithm (LinUCB): the UCB score may be maximized with cluster-specific linear models:

$$a = arg {max}_{a} {\underbrace{{x}_{c}^{T} {θ}_{{x}_{t} , a} + α \sqrt{{x}_{c}^{T} {A}_{{x}_{t} , a}^{- 1} {x}_{c}}}}_{f ( {x}_{c} , {x}_{t} , a )} , {A}_{{x}_{t} , a} .$$

The term Aₓ_{ₜ}_{,a} denotes co-variance matrix for action a was chosen in cluster xₜ.

For the softmax algorithm: probabilistic action selection may be based on cluster-specific values:

$$P ( a ) = \frac{exp ( η \cdot {\underbrace{{x}_{c}^{T} {θ}_{{x}_{t} , a}}}_{f ( {x}_{c} , {x}_{t} , a )} )}{{\sum }_{{a}^{′}} exp ( η \cdot {x}_{c}^{T} {θ}_{{x}_{t} , {a}^{′}} )}$$

The term η denotes a temperature parameter controlling exploration.

For the cluster algorithm: the action with the highest average reward in the cluster may be chosen:

$$a = arg {max}_{a} {\underbrace{Q ( {x}_{t} , a )}}_{f ( {x}_{c} , {x}_{t} , a )} .$$

The term Q(xₜ, a) denotes the average reward of action a in cluster xₜ.

For the KNN algorithm: the average reward of the k-nearest clusters to xₜ may be used:

$$a = arg {max}_{a} {\underbrace{\frac{1}{k} {\sum }_{c ∈ {𝒩}_{k} ( {x}_{t} )} Q ( c , a )}}_{f ( {x}_{c} , {x}_{t} , a )} .$$

The term [symbol] (xₜ) denotes a set of k-nearest clusters to xₜ.

For the LSHN algorithm: this may include an assignment to the LSHN bucket h(xₜ) and use of the best action based on:

$$a = arg {max}_{a} {\underbrace{N ( h ( {x}_{t} ) , a )}}_{f ( {x}_{c} , {x}_{t} , a )} .$$

The term h(xₜ) denotes the LSHN bucket (cluster) for xₜ.

For the tree-bandit algorithm: the contexts may be partitioned into leaves (clusters) via a decision tree:

$$a = arg {max}_{a} {\underbrace{Q ( {x}_{t} , a ) + \sqrt{\frac{log N ( {x}_{t} )}{n ( {x}_{t} , a )}}}}_{f ( {x}_{c} , {x}_{t} , a )} .$$

The term N(xₜ) denotes total pulls in leaf xₜ, wherein the term n(xₜ, a) represents pulls of action a.

For the radius neighborhood algorithm: an average reward of contexts within radius r of x_{c} may be used:

$$a = arg {max}_{a} {\underbrace{\frac{1}{\vert {B}_{r} ( {x}_{c} ) \vert} {\sum }_{x ∈ {B}_{r} ( {x}_{c} )} r ( x , a )}}_{f ( {x}_{c} , {x}_{t} , a )} .$$

The term Bᵣ(x_{c}) denotes contexts within radius r of centroid x_{c}.

For the cluster-specific UCB algorithm with time slots: the time slots may be chosen based on:

$$a = arg {max}_{a} {\underbrace{{μ}_{{x}_{t} , a} + β {σ}_{{x}_{t} , a}}}_{f ( {x}_{c} , {x}_{t} , a )} .$$

The terms μₓ_{ₜ}_{,a} and σₓ_{ₜ}_{,a} denote mean and standard deviation of rewards for time slot a in cluster xₜ.

As stated above, the reward function for all algorithms may have a reward r represented by:

$$r = tanh ( 1 - \frac{diff\_hr}{{diff\_}_{median}} ) + 1.$$

The term diff_hr denotes a time difference in hours, and the term diff median denotes a median time difference for normalization. Each algorithm leverages cluster assignments (xₜ) as a sufficient statistic for the context, with actions derived from cluster centroids (x_{c}) and cluster-specific parameters. The reward function thus ensures non-linear feedback based on temporal proximity.

Continuing with the reward function, a term of

$$tanh ( 1 - \frac{\vert {x}_{t} - {x}_{c} \vert}{median} ) + 1$$

represents a continuous function mapping of a scaled distance to a reward value. The hyperbolic tangent function, tanh is used to smoothly map the input to a range between −1 and 1. Adding 1 shifts the range to [0, 2], which can be useful for ensuring non-negative rewards.

Continuing with FIG. 6, a sample algorithm structure for generating the CBCABM may be described in Table 1 below.

TABLE 1
Sample algorithm structure for generating the CBCABM.

```
Algorithm 1 CBCABM Context-Based Clustering Assignment Bandit Model for Predicting
an Optimal Electronic Document Sending Time
Below is a CBCABM algorithm that can be adapted to various algorithms for the
predicting an optimal electronic document sending time. Assume that there is a set
of users U grouped into clusters C, wherein each cluster represents users with
similar engagement patterns.
Let C(xₜ) be the cluster assignment function based on context xₜ, so that a user with
context xₜ is assigned to cluster c ϵ C. The loop iterates over user activities and
applies the selected algorithm to generate time recommendations.
  Input: User activity logs: U = u₁, u₂, . . . , uₙ
  Contextual features: C = c₁, c₂, . . . , cₘ
  Historical time recommendations: T = t₁, t₂, . . . ,tₖ
  Algorithm selection: ALG (e.g., Random, Popularity, LinGreedy, etc.)
  Hyperparameters: H(e.g., ϵ, α, K, etc.) wherein Number of clusters: K, Exploration
  parameter: ϵ, Learning rate: α
  Output: Time recommendations: T = t₁, t₂, . . . , tₙ
  1. Initialize: - Initialize algorithm-specific parameters (e.g., clusters, bandit arms,
reward estimates, etc.)
    Preprocess contextual features C (e.g., normalize, encode, etc.)
    Extract relevant features from user activity logs U
  2. For each user activity uᵢ in U:
    a. Extract contextual features cᵢ for uᵢ
    b. After selecting arm aⱼ and observing reward rₜ, update the model
      parameters:
      $For linear models : {θ}_{a} ← {θ}_{a} + η ( {r}_{t} - {x}_{t}^{T} {θ}_{a} ) {x}_{t} .$
      For clustering models: [symbol]   , C_{c} ← [symbol]   , C_{c} + η(rt − [symbol]   , C_{c}).
    c. Select algorithm ALG: a = arg_{maxf}(xₜ, a, r_{a,t})
```

The following terms and their associated definitions (as shown in Table 2) may be used in the sample algorithm structure that was previously described in Table 1.

| | |
|---|---|
| - | X: Set of contexts, where xₜ ϵ [symbol] is the context at time t. |
| - | A: Set of arms (time slots), where aⱼ ∈ A is a specific time slot. |
| - | C: Set of clusters, where C_{c} ∈ C is a specific cluster. |
| - | θ: Model parameters (e.g., weights for linear models, posterior distributions, etc.). |
| - | rₜ: Observed reward at time t. |
| - | r\hat{ }ⱼ: Estimated reward for arm aⱼ. |
| - | ϵ: Exploration probability for ϵ-greedy. |
| - | α: Temperature parameter for Softmax. |
| - | β: Exploration parameter for UCB. |
| - | D: Distance metric for clustering. |
| - | K: Number of nearest clusters for K-nearest Clusters. |
| - | R: Radius for Radius-Based Clustering. |

Table 2. Terms and definitions for utilization in the sample algorithm structure.

An objective function may also be used to quantify a maximization of the cumulative reward over T rounds:

$${\sum }_{t = 1}^{T} {r}_{t} ,$$

The arm aⱼ is selected at time t based on the model type: aⱼ=argmaxₐ∈A f(xₜ, rₜ, a), where f is a modular function that can be defined as described below for the various algorithms.

For the popularity algorithm: ƒ(xₜ, rₜ, a)=

[symbol]

For the random algorithm: ƒ(xₜ, rₜ, a)=Uniform(A).

For the linear greedy algorithm:

$$f ( {x}_{t} , {r}_{t} , a ) = \{ \begin{matrix}{x}_{t}^{T} {θ}_{a} & with probability 1 - ϵ , \\ Uniform ( A ) & with probability ϵ .\end{matrix}$$

For the linear Thompson sampling algorithm:

$$f ( {x}_{t} , {r}_{t} , a ) = {x}_{t}^{T} \text{?} ,$$

wherein [symbol] is sampled from the posterior distribution P(θₐ|data).

For the cluster Thompson sampling:

$$f ( {x}_{t} , {r}_{t} , a ) = {x}_{t}^{T} {\text{?}}_{, {C}_{c}} ,$$

wherein [symbol] _{,Cc} is sampled from the cluster-specific posterior distribution P(θ_{a,Cc}|data).

For the linear UCB algorithm:

$$f ( {x}_{t} , {r}_{t} , a ) = {x}_{t}^{T} {θ}_{a} + β \sqrt{{x}_{t}^{T} {Σ}_{a}^{- 1} {x}_{t}} .$$

For the softmax algorithm:

$$f ( {x}_{t} , {r}_{t} , a ) = \frac{exp ( α \cdot {x}_{t}^{T} {θ}_{a} )}{{\sum }_{{a}^{′} ∈ A} exp ( α \cdot {x}_{t}^{T} {θ}_{{a}^{′}} )} .$$

For the cluster algorithm: ƒ(xₜ, rₜ, a)= [symbol] _{,Cc}.

For the K-nearest cluster algorithm:

$$f ( {x}_{t} , {r}_{t} , a ) = \frac{1}{K} {\sum }_{{c}^{′} ∈ {Nearest}_{K} ( {C}_{c} )} {\hat{r}}_{a , {c}^{′} ,}$$

wherein the Nearest_{K} (C_{c}) are the K nearest clusters to C_{c}.

For the LSHN algorithm:

$$f ( {x}_{t} , {r}_{t} , a ) = {\hat{r}}_{a , LSH ( {x}_{t} )} ,$$

wherein the LSH(xₜ) is the cluster assigned by the locality-sensitive hashing.

For the tree-bandit algorithm:

$$f ( {x}_{t} , {r}_{t} , a ) = {\hat{r}}_{a , Leaf ( {x}_{t} ) ,}$$

wherein Leaf(xₜ) is the leaf node in the hierarchical tree corresponding to xₜ.

For the radius-based clustering:

$$f ( {x}_{t} , {r}_{t} , a ) = \frac{1}{\vert {C}_{R} \vert} {\sum }_{{c}^{′} ∈ {C}_{R}} {\hat{r}}_{a , {c}^{′} ,}$$

wherein C_{R} is the set of clusters within radius R of xₜ.

Continuing with FIG. 6, a detailed example process of the generation of the CBCABM may be subsequently described. Starting from the inputs and assumptions as described above in FIG. 5, the detailed process may include receiving inputs, generating the CBCABM, and creating the predictive outputs. The detailed example process may include the incorporation of various learning algorithms in the CBCABM that may include the various learning algorithms as described above to create outputs for the electronic document time.

An initial step in the detailed example process may include receiving inputs of user information (e.g., demographics, past behavior), electronic document attributes (e.g., type, urgency, etc.), and/or historical interaction data (e.g., past time choices, outcomes, etc.). Additional attributes may include number documents to be signed and a completion status for the electronic document. The initial step may also include incorporating the various assumptions as descry bed above, e.g., users' preferences for the timing of electronic document signings vary based on contextual factors like time of day, day of the week, electronic document type, and user characteristics (e.g., demographics and identification).

Another step may include extracting relevant features from the input data, including user demographic features (e.g., job, location, gender, age, etc.), user identification (e.g., name, etc.), electronic document features (e.g., type, size, etc.), and contextual features (e.g., time of day, day of the week). These extracted relevant features may be transform from categorical features into numerical representations (e.g., using one-hot encoding) for the CBCABM's compatibility.

Another step may include selection of a learning algorithm as part of the generation of the CBCABM. The determination and selection of the learning algorithm for incorporation into the CBCABM as part of the generation of the CBCABM may include consideration of the problem being solved and the available data to solve the problem. For instance, the selection of the linear greedy learning algorithm would be, as described above, the need to balance exploration concept and exploitation concept of the CBCABM by enabling a selection of an action (e.g., electronic document signing time recommendation) with the highest estimated reward (e.g., click-through rate) based on linear models.

In another example, the selection of the KNN algorithm may be due to the need to recommend electronic data sending times based on similar historical contexts. In another example, the selection of the random algorithm by itself may be due to a need to recommend electronic document sending time slots randomly without considering historical data or electronic document context. In another example, the selection of the popularity algorithm by itself may be due to a need to recommend popular time slots based on historical data, regardless of user or electronic document context.

In another example, the selection of the clusters algorithm may be due to a need to group similar contexts into clusters and recommend electronic data sending times based on the cluster's historical performance. In another example, the selection of the radius algorithm may be due to a need to recommend electronic document sending times within a certain radius of the current context, considering similarities in historical data.

In another example, the selection of the LSHN algorithm may be due to a need to find nearest neighbors efficiently and recommend electronic document sending times based on their historical performance. In another example, the selection of the cluster Thompson sampling algorithm may be due to simply needing to balance the exploration concept and the exploitation in a contextual setting of the CBCABM.

Continuing with the steps, another step in the detailed example process may include training the CBCABM. The training of the CBCABM may involve training each algorithm using historical interaction data to estimate the reward associated with different actions (e.g., electronic document sending time slots) given the contextual features. These algorithms may also be updated by updating the algorithm's model parameters based on the chosen algorithm's update rule (e.g., gradient descent for linear greedy, distance metrics for KNN, etc.). Examples of the distance metrics for the KNN may include, but are not limited to Euclidean distance, Manhattan distance, Minkowski distance, Hamming distance, etc.

Another step may include predicting an action comprising an optimal electronic document sending time as derived from the CBCABM based on the selected algorithm being incorporated into the CBCABM. For instance, if the selected algorithm is linear greedy, then the predicted action may relate to selecting the electronic document sending time slot with the highest estimated reward based on the linear model. If the selected algorithm is KNN, then the predicted action may relate to recommending electronic document sending times based on historical data from the KNN of the current context.

If the selected algorithm is random, then the predicted action may relate to randomly selecting an electronic document sending time slot without considering historical data. If the selected algorithm is popularity, then the predicted action may relate to recommend the most popular electronic document sending time slot regardless of context. If the selected algorithm is clusters, then the predicted action may relate to recommending electronic document sending times based on the cluster's historical performance.

If the selected algorithm is radius, then the predicted action may relate to recommending electronic document sending times within a certain radius of the current context. If the selected algorithm is LSHN, then the predicted action may relate to finding nearest neighbors efficiently using locality-sensitive hashing and recommending electronic document sending times based on their historical performance. If the selected algorithm is cluster Thompson sampling, then the predicted action may relate to using Thompson Sampling within clusters to balance the exploration concept and exploitation concept of the CBCABM.

Another step in the detailed example process may include updating the CBCABM. The CBCABM may be updated based on the hyperparameters used and the selected algorithm's update rule.

Another step in the detailed example process may include outputting the predicted action to a user. For instance, the outputting may be the CBCABM outputting the recommended electronic document sending times to the user based on the selected algorithm's decision and the best hyperparameters utilized.

Another step in the detailed example process may include a performance evaluation of the CBCABM. This may be achieved by evaluating the performance of each algorithm incorporated in the CBCABM over time using relevant metrics to assess effectiveness and identify areas for improvement. By following these steps and incorporating a variety of algorithms into the CBCABM, the CBCABM can generate timely and personalized recommendations for electronic document signing times within the electronic document signing platform, enhancing user experience and efficiency and optimizing usage of system resources.

To ensure an optimal performance of the CBCABM, several conditions may be implemented. One condition may relate to feature space complexity, wherein the input parameters should be well-defined and relevant to the recommendation task. This is because incorporating too many irrelevant features can increase the complexity of the CBCABM without necessarily improving performance.

Another condition may relate to data quality and consistency since the effectiveness of the CBCABM relies on the quality and consistency of the input data. Thus, inaccurate or inconsistent data can lead to sub-optimal recommendations.

Another condition may relate to the contextual information, wherein the CBCABM relies on contextual information to make recommendations. Therefore, the input parameters should capture relevant contextual information about the user, the electronic document, and the electronic document singing environment in which the recommendation is being made.

Another condition may relate to scalability, wherein the CBCABM's scalability may be limited by the dimensionality of the input feature space and the computational resources available for training and inference.

Another condition may relate to exploration versus exploitation trade-off. The CBCABM needs to balance exploration (trying new recommendations to learn more about their effectiveness) and exploitation (leveraging known effective recommendations) based on the input parameters and the current state of knowledge.

Another condition may relate to generalization such that the CBCABM may be able to generalize well to unseen contexts or situations. Therefore, the input parameters should capture the essential characteristics of the recommendation task without overfitting to specific instances or scenarios.

Another condition may relate to ethical and legal considerations. This may be because the input parameters should adhere to ethical and legal guidelines regarding privacy, fairness, and transparency. Certain types of information may be off-limits or require special handling to ensure compliance like personally identifiable information.

Another condition may relate to model interpretability. That is, the interpretability of the CBCABM's recommendations may be limited by the complexity of the input parameters. Therefore, it may be essential to strike a balance between the CBCABM's performance and interpretability. By carefully considering these limitations and boundaries when selecting and defining input parameters, a more effective and robust CBCABM may be designed for electronic document signing platform.

To test whether the CBCABM has optimal performance, wherein these conditions are implemented, the CBCABM may be subjected to testing in diverse scenarios for vigorous evaluations to test the CBCABM's robustness and repeatability. One testing scenario, the CBCABM may be tested with varying user contexts, such as Account Opening Entity Type, number of electronic documents processed, and varying geographic regions to ensure its adaptability and effectiveness across a broad spectrum of users.

Another testing scenario may involve testing the CBCABM with different electronic document types, ranging from contracts and agreements to invoices and forms to evaluate its performance across various use cases. These scenarios allow for the identification of potential biases, limitations, or vulnerabilities in the CBCABM's outputs. Repeatability tests may involve running the CBCABM multiple times with identical or similar inputs to verify the consistency and reproducibility of its recommendations. By systematically exploring various scenarios and conducting rigorous tests of robustness and repeatability, it can be demonstrated with confidence the reliability and effectiveness of the CBCABM in predicting recommendations regarding electronic document sending times, ultimately enhancing user experience and operational system efficiency.

Ongoing performance monitoring (OPM) may be needed to continuously monitor the performance of the CBCABM to ensure its optimal performance. OPM may refer to the set of on-going testing activities to be performed by the developers, users, or their delegates in order to establish that the CBCABM continues to perform as intended and to provide a periodic measure of model uncertainty where applicable.

The OPM of CBCABM may involve a comprehensive evaluation framework based on high, medium, and low metrics, each with first and second thresholds. The high metrics may signify critical performance indicators that require immediate attention if breached beyond the first threshold, indicating a severe deviation from the desired outcome. These might include metrics such as electronic document delivery delays exceeding a certain threshold or a significant drop in user engagement.

The low metrics may represent optimal performance indicators, and meeting or surpassing the first threshold indicates satisfactory system performance. Examples could include high electronic document delivery accuracy. However, breaching the second threshold for high threshold metric may suggest a declining trend that requires proactive intervention to maintain satisfactory performance levels.

The medium metrics may serve as intermediate indicators, signaling areas where performance may be satisfactory but could benefit from further optimization. Monitoring these metrics allows for timely adjustments to the CBCABM, ensuring that it and the electronic document signing platform remains agile and responsive to evolving client needs and business objectives. By employing this multi-tiered approach to performance monitoring, it can provide a mechanism for effectively balancing operating system stability with the continuous pursuit of improvement and innovation.

Indeed, the detailed mathematical formulation of predetermined thresholds for key performance monitoring metrics in the context of CBCABM may involve defining threshold functions that dynamically adapt based on the observed performance metrics.

The CBCABM may include these performance monitoring metrics by incorporating predetermined thresholds of upper, medium, and lower thresholds for exploration-exploitation trade-offs. These predetermined thresholds are defined in terms of mean p and standard deviation a of the reward distributions. The formulation may be designed to balance exploration and exploitation by dynamically adjusting the decision boundaries based on the uncertainty and expected reward of each arm.

The upper, medium, and lower thresholds are defined in terms of the mean μ and standard deviation σ of the reward distributions. These thresholds (T) guide the exploration-exploitation trade-off and are shown below.

For the upper threshold (Tᵤₚₚₑᵣ):

$${T}_{upper} ( a , {C}_{c} ) = {μ}_{a} , {C}_{c} + β \cdot {σ}_{a} , {C}_{c} ,$$

wherein μₐ,C_{c} is the mean reward for arm a in cluster C_{c}. The term σₐ,C_{c} is the standard deviation of the reward for arm a in cluster C_{c}. The term β is the exploration parameter, which controls the weight of uncertainty. Arms with rewards above this upper threshold are considered high-confidence exploitable.

For the medium threshold (T_{medium}):

$${T}_{medium} ( a , {C}_{c} ) = {μ}_{a} , {C}_{c} .$$

Arms with rewards around this medium threshold are candidates for moderate exploration.

For the medium threshold (T_{lower}):

$${T}_{lower} ( a , {C}_{c} ) = {μ}_{a} , {C}_{c} - β \cdot {σ}_{a} , {C}_{c} ,$$

Arms with rewards below this lower threshold are considered high-uncertainty candidates for exploration.

The arm aⱼ may be selected at time t based on the context xₜ and for the various thresholds: aⱼ=arg_{max,a∈A}ƒ(xₜ, rₜ, a), where ƒ is a modular function defined as shown below for the various thresholds.

For exploitation (Tᵤₚₚₑᵣ): if the expected reward for an arm a exceeds the upper threshold: ƒ(xₜ, rₜ, a)=μₐ,C_{c}+β·σₐ,C_{c}. This arm may be selected for exploitation.

For moderate exploration (T_{medium}): if the expected reward for an arm a is around the medium threshold: ƒ(xₜ, rₜ, a)=μₐ,C_{c}. This arm may be selected for moderate exploration (e.g., epsilon-greedy or softmax).

For exploration (T_{lower}): if the expected reward for an arm a is below the lower threshold: ƒ(xₜ, rₜ, a)=μₐ,C_{c}−β·σₐ,C_{c}. This arm may be selected for exploration (e.g., random selection or Thompson Sampling).

A reward update may also be computed in association with these predetermined thresholds. After selecting arm aⱼ and observing reward rₜ, update the model parameters by updating the mean reward and the standard deviation via the equations as shown below.

For updating the mean reward: μₐ,C_{c}←μₐ,C_{c}+η(rₜ−μₐ,C_{c}).

For updating the standard deviation:

$${σ}_{a} , {C}_{c} ← \sqrt{{σ}_{a , {C}_{c}}^{2} + η ( {( {r}_{t} - {μ}_{a} , {C}_{c} )}^{2} - {σ}_{a , {C}_{c}}^{2} )} .$$

Additionally, the reward update may also correlate with specific elements corresponding to the various algorithms as shown below.

For the UCB algorithm:

$$UCB ( a ) = {μ}_{a} , {C}_{c} + β \cdot {σ}_{a} , {C}_{c} .$$

For the softmax algorithm, the probability may be defined as:

$$P ( a \vert {x}_{t} ) = \frac{exp ( α \cdot {μ}_{a} , {C}_{c} )}{{\sum }_{{a}^{′} ∈ A} exp ( α \cdot {μ}_{{a}^{′}} , {C}_{c} )} .$$

For a cluster assignment of the CBCABM: C_{c}=Cluster (xₜ).

These formulations provide a unified framework for performance monitoring for the CBCABM. The predetermined upper, medium, and lower thresholds dynamically balance exploration and exploitation based on the mean and standard deviation of the reward distributions. The generalized function is adaptable to a chosen model type (which is the CBCABM in the present application), enabling flexible and efficient recommendation strategies. The single objective function ensures that the model is optimized for cumulative reward over time.

Additionally, these formulations ensure that the thresholds dynamically adapt to changes in the distribution of performance metrics. Specifically, the first threshold may be set based on the mean and standard deviation of the metric, providing a baseline for performance evaluation. The second threshold may then be set at a certain distance from the first threshold, allowing for a more nuanced assessment of performance. By continuously monitoring the performance metrics and comparing them to the dynamically adjusted thresholds, the CBCABM can make informed decisions about when to take actions to improve the time recommendation system. As such, this mathematical formulation may provide a robust framework for setting thresholds that are sensitive to changes in performance metrics while allowing for flexibility in adaptation over time.

Additionally, to ensure optimal performance of the CBCABM, overfitting reduction processes may also be implemented. Reducing overfitting in the CBCABM may involve several strategies to ensure that the CBCABM generalizes well to unseen data while effectively learning from the available context. One example technique may include regularization. This may include apply regularization techniques such as L1 or L2 regularization to the LSHN algorithm to penalize large weights in the CBCABM. Regularization helps to prevent the CBCABM from fitting noise in the training data and encourages it to learn more robust patterns.

Another example technique may include feature engineering. That is, by carefully designing and selecting relevant features for the CBCABM. Too many irrelevant features can lead to overfitting.

Another example technique may include cross-validation. This may include utilizing cross-validation techniques to evaluate the CBCABM's performance on multiple folds (manifolds) of the data. This may helped ensure that the CBCABM's performance is consistent across different subsets of the data and can help identify overfitting.

Another example technique may include model complexity. This may include considering using simpler model architectures or reducing the complexity of the CBCABM to prevent overfitting. A complex model, such as CBCABM, with a large number of parameters are more prone to overfitting, especially when the training data is limited.

Another example technique may include data augmentation. This may include augmenting the training data by introducing variations or perturbations to the input features by increasing or reducing number of features or contexts. This may help expose the CBCABM to a more diverse range of scenarios and reduces the risk of overfitting to specific instances in the training data.

By applying these techniques, overfitting may be reduced in the CBCABM and improve the CBCABM's performance.

In the context of the CBCABM, a plot of recall versus worst K to best K in the KNN algorithm may offer valuable insights into the CBCABM's performance across different values of K. In such a plot, the x-axis may represent the range of K values, typically from the worst K (e.g., 1 or a small value) to the best K (e.g., a larger value). The y-axis may denote the corresponding recall scores achieved by the KNN algorithm for each K value. As K increases from the worst to the best, the plot may illustrate how the recall of the KNN algorithm evolves. At lower K values, such as 1 or 2, the KNN algorithm considers only a small number of nearest neighbors, resulting in potentially limited coverage of relevant items in the recommendation list. Consequently, the recall may be relatively low at these K values. However, as K increases, the algorithm incorporates a larger number of neighbors, leading to a broader exploration of the item space and potentially capturing more relevant items. Consequently, the recall tends to improve with increasing K until reaching an optimal point where further increasing K may lead to diminishing returns or even degradation in performance due to over-smoothing or noise.

Interpreting such a plot can help to identify the range of K values that yield the highest recall for the recommendation task by helping to determine the optimal balance between local and global information in the recommendation process. Moreover, insights gained from this plot can inform the selection of the most suitable K value for deployment, ensuring that the KNN algorithm achieves optimal performance in providing personalized and relevant recommendations the users.

Initially, as K increases from its worst value, precision exhibits a decreasing trend. This is because with larger K, the algorithm considers more neighbors, potentially including less relevant ones, leading to a dilution of precision. However, recall tends to increase as K increases since more neighbors are considered, capturing a broader range of relevant items.

Regarding the performance metrics of NDCG and MAP, which may account for both relevance and item position in the recommendation list, these performance metrics may initially increase as K grows from its worst value, reflecting the improved coverage of relevant items. However, beyond an optimal point, further increasing K may plateau in NDCG and MAP due to the inclusion of less relevant neighbors. As K approaches its best value, recall, NDCG, and MAP may plateau or start to decline, indicating that the optimal balance between precision and recall has been reached. Precision, on the other hand, may continue to decline as K increases, reflecting the increasing likelihood of including irrelevant neighbors in the recommendation list.

Overall, such a plot may provide insights into the trade-off between precision and recall in the KNN algorithm for the recommendation. By analyzing the trends in recall, precision, NDCG, and MAP across different values of K, the optimal value may be identified that maximizes the relevance of recommendations while maintaining acceptable levels of precision.

For the CBCABM, comparing various algorithms incorporated in the CBCABM may be essential for identifying the most effective approach. Beginning with benchmark random and popularity algorithms, these serve as foundational baselines for assessing the performance of more complex algorithms. The random algorithm may assign actions randomly, providing a simple yet necessary benchmark for evaluating whether more sophisticated algorithms offer tangible improvements. Meanwhile, the popularity algorithm may recommend actions based on historical data, prioritizing those with the highest observed success rates. Although straightforward, this approach may lack adaptability to changing contexts and fail to capture nuanced patterns in user behavior.

Moving to more advanced algorithms, KNN and LSHN algorithms leverage the similarity of contexts to make recommendations. KNN may identify the k most similar contexts to the current context and selects actions based on their outcomes, while LSHN may efficiently approximate nearest neighbors, facilitating faster recommendation generation. These algorithms may excel in scenarios where context similarity is crucial, allowing for personalized recommendations tailored to individual users' preferences.

Cluster algorithms, such as k-means clustering, partition the data into clusters based on contextual features and recommend actions based on cluster centroids or cluster-specific policies. By grouping similar contexts together, cluster algorithms capture underlying patterns and preferences shared among users within each cluster, enabling more targeted recommendations. However, the effectiveness of cluster algorithms heavily depends on the quality of feature representation and the choice of clustering parameters.

When comparing these approaches in terms of recall, which measures the proportion of relevant items retrieved among all relevant items, and NDCG, which considers both the relevance and the position of items in the recommendation list, then KNN, LSHN, and clustering algorithms generally outperform random and popularity algorithms. By leveraging contextual information, these algorithms can provide more relevant and personalized recommendations, leading to higher recall and NDCG scores. However, the performance may vary depending on the quality of the contextual features, the choice of algorithm parameters, and the nature of the recommendation task. Therefore, thorough experimentation and evaluation are necessary to determine the most effective approach as to which algorithm is incorporated into the CBCABM based on evaluating recall and NDCG terms.

Aside from overfitting reduction, sensitivity analysis may also be considered for the CBCABM. Sensitivity analysis in CBCABM may involve assessing the robustness of the CBCABM's recommendations to changes in various factors, such as the choice of hyperparameters, feature selection, etc.

An example of sensitivity analysis may include hyperparameter tuning sensitivity. This may be performed by investigating how changes in hyperparameters affect the CBCABM's performance and recommendations. This may include parameters such as learning rate, exploration-exploitation trade-off using τ, L1, and L2. Experiments may be performed with different values of these hyperparameters to evaluate their impact on the CBCABM's performance metrics.

Another example of sensitivity analysis may include feature sensitivity analysis. This may involve assessing the sensitivity of the CBCABM to different features or combinations of features by increasing or reducing number of features. This may involve analyzing the importance of individual features and understanding how changes in feature values impact the model's recommendations. Experiments may be performed where specific features are perturbed or removed such as, Account opening Entity type and number of documents, and observing the resulting changes in the CBCABM's behavior and performance.

Another example of sensitivity analysis may include contextual sensitivity. This may include exploring how the CBCABM's recommendations vary across different contexts or user segments by analyzing whether the CBCABM's recommendations are consistent across different subsets of the data or if certain contexts lead to more uncertainty or variability in the recommendations. This may involve segmenting the data based on user demographics like location/region, behavior, or other contextual factors and evaluating the CBCABM's performance within each segment.

Another example of sensitivity analysis may include algorithm sensitivity. This may include comparing the performance of different algorithms incorporated into the CBCABM or variations of the same algorithm by evaluating how sensitive the CBCABM's recommendations are to the choice of algorithm and identify which algorithms are most effective for the recommendation task. Experiments may be performed with other algorithms such as epsilon-greedy, Thompson sampling, or linear upper confidence bound and assess their performance under various conditions.

Another example of sensitivity analysis may include robustness to noise and outliers. This may be performed by assessing the robustness of the CBCABM to noise and outliers in the data. Noise or anomalies may be introduced into the training data and then evaluate how the CBCABM's recommendations are affected. This helps to understand whether the CBCABM's performance is resilient to noisy data or if it tends to overfit or underperform in the presence of outliers.

By conducting sensitivity analysis in the CBCABM, insights can be gained into the robustness and reliability of the CBCABM's recommendations and areas for improvement or optimization may be identified.

As described above, the generating the CBCABM may be a complex process involving considerations for overfitting reduction and sensitivity analysis. Additionally, benchmarks for the learning algorithms may also be utilized as part of the generation. Benchmark library used in the software code for generating the CBCABM may include training, scoring, and evaluating each learning algorithm using cross-validation benchmarks with manifolds for the cross-validation from the training data. Otherwise, the CBCABM trains on the training data and evaluates on the testing data. The learning algorithms (which may be represented in the evaluation as a value) may be benchmarked using dictionary with names (i.e., keys).

The inputs of the CBCABM may include training data, testing data, cross-validation data, user features data frame data, envelope data, columns to encode data, batch size, verbose command, decisions data, rewards data and context data. The training data may be used to train the CBCABM and should include a row for each training sample. The testing data may to generate recommendations or predictions and the data should have a row for each testing sample.

The cross-validation data may include a number of folds in the training data to use for cross-fold validation. A grouped K-fold iterator may be used to ensure that the same envelope is not contained in different folds. When using cross-validation, the test data must be “none”. The user features data frame data may include user features for each envelope identifier, wherein each row of data should include the envelope identifier and a list of user features. The envelope data may include a list of envelope features such as entity type, region name, etc. and can be a subset of the total features. If the envelope data is listed as “none”, then all the features are presently used. Outliers in the envelope data may be excluded from the dataset and data extraction. For example, envelope data such as time points when the electronic document is sent early in the morning or late in the afternoon may be excluded. Additionally, the envelope data may also be transformed such that instead of a label name for reach individual U.S. region that the envelope data originates from, the data may be rename all to just U.S. or something similar and then group the data based on the envelope ID.

The columns to encode data may map each user feature datapoint to a valid data encoding. The batch size may be used to chunk data into batch sizes. The verbose command may include a Boolean command and a setting wherein default=false. The verbose command may also include a command for whether to print progress status or not. The decisions data may include a list of decisions being made. The rewards data may include rewards received corresponding to the decisions. The contexts data may include a context under which each decision is made.

The CBCABM for electronic document signing time recommendation may rely on diverse data inputs to generate personalized suggestions. User-specific inputs may include historical signing patterns, frequency of document handling, and user preferences recorded through past interactions with the electronic document signing platform. Electronic document-related features may also include urgency, type, and complexity that provides a contribution to valuable context data. Additional context feature data may include external factors, e.g., time of day and day of the week, may also be included to enhance the CBCABM's understanding of temporal patterns. These inputs, drawn from various sources within the electronic document signing platform may enable the CBCABM to dynamically adapt its recommendations based on the contextual nuances of both the users and the electronic documents, enhancing the precision and relevance of the suggested signing times.

The data from the electronic document signing platform may provide a valuable representation of user onboarding for the CBCABM due to the comprehensiveness of such data. This may be because such data encapsulates the diverse set of actions and decisions made during the user on-boarding process, offering a rich source of information. For instance, such data may include electronic document submissions to electronic signature timings and thus, providing a nuanced understanding of the user's behaviors and preferences. Leveraging this dataset in the CBCABM would enables the CBCABM to learn intricate patterns and thus, facilitating personalized recommendations tailored to individual client journeys. This would then enhance the efficacy of the CBCABM, ensuring it adapts dynamically to varying on-boarding scenarios, ultimately optimizing the user experience with the electronic document signing platform.

Although the invention has been described with reference to several embodiments, it is understood that the words that have been used are words of description and illustration, rather than words of limitation. Changes may be made within the purview of the attached claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the attached claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the attached claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of generating a contextual-based cluster assignment bandit model for predicting an optimal electronic document sending time, the method being implemented by at least one processor, the method comprising:
receiving input data related to an electronic document transmission;
extracting contextual features from the input data;
generating a contextual-based cluster assignment bandit model (CBCABM) based on the extracted contextual features representing an arm of the CBCABM and based on a selection of at least one learning algorithm from among a plurality of learning algorithms that maximizes an expected reward function for the CBCABM;
predicting an action comprising an optimal electronic document sending time as derived from the CBCABM; and
outputting the predicted action to a user.

2. The method of claim 1, wherein the input data comprises a user metric, a document attribute, and a historical interaction data;
wherein the user metric comprises a user demographic and a user identification;
wherein the document attribute comprises a document type and an urgency identifier; and
wherein the historical interaction data comprises at least one from among a historical sending time, a past action, and a past outcome.

3. The method of claim 2, further comprising:
training the CBCABM based on the historical interaction data to estimate a reward associated with the predicted action that maximizes the expected reward function;
performing a feedback loop mechanism as part of the training of the CBCABM; and
updating the CBCABM by fine-tuning hyperparameters of the CBCABM in conjunction with an updating rule associated with the selected at least one learning algorithm.

4. The method of claim 3, wherein the updating rule comprises at least one from among a gradient descent function, a distance measurement function, a cosine similarity function, and a probability function; and
wherein the feedback loop mechanism is based on at least one from among a user feedback, a performance evaluation of the CBCABM, and a changing need of a business organization that utilizes the CBCABM.

5. The method of claim 3, wherein the performing the feedback loop mechanism further comprises:
performing an evaluation of the CBCABM based on a predetermined evaluation framework with a predetermined performance threshold metric based on a mean and a standard deviation of a rewards distribution.

6. The method of claim 1, wherein the CBCABM comprises a reinforcement learning model;
wherein the plurality of learning algorithms comprises a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHN) learning algorithm, a cluster learning algorithm, a radius neighborhood learning algorithm, and a tree bandit learning algorithm; and
wherein the expected reward function comprises an argmax function with an estimated reward term representing an exploitation concept and a confidence interval representing an exploration concept.

7. The method of claim 1, further comprising:
optimizing an epsilon-greedy algorithm based on adjusting an epsilon value to provide a balance between an exploitation concept and an exploration concept associated with a performance of the CBCABM.

8. A computing apparatus for a contextual-based cluster assignment bandit model for predicting an optimal electronic document sending time, comprising:
a processor;
a memory;
a display; and
a communication interface coupled to each of the processor, the memory, and the display, wherein the processor is configured to:
receive input data related to an electronic document transmission;
extract contextual features from the input data;
generate a contextual-based cluster assignment bandit model (CBCABM) based on the extracted contextual features representing an arm of the CBCABM and based on a selection of at least one learning algorithm from among a plurality of learning algorithms that maximizes an expected reward function for the CBCABM;
predict an action comprising an optimal electronic document sending time as derived from the CBCABM; and
output the predicted action to a user.

9. The computing apparatus of claim 8, wherein the input data comprises a user metric, a document attribute, and a historical interaction data;
wherein the user metric comprises a user demographic and a user identification;
wherein the document attribute comprises a document type and an urgency identifier; and
wherein the historical interaction data comprises at least one from among a historical sending time, a past action, and a past outcome.

10. The computing apparatus of claim 9, wherein the processor is further configured to:
train the CBCABM based on the historical interaction data to estimate a reward associated with the predicted action that maximizes the expected reward function;
perform a feedback loop mechanism as part of the training of the CBCABM; and
update the CBCABM by fine-tuning hyperparameters of the CBCABM in conjunction with an updating rule associated with the selected at least one learning algorithm.

11. The computing apparatus of claim 10, wherein the updating rule comprises at least one from among a gradient descent function, a distance measurement function, a cosine similarity function, and a probability function; and
wherein the feedback loop mechanism is based on at least one from among a user feedback, a performance evaluation of the CBCABM, and a changing need of a business organization that utilizes the CBCABM.

12. The computing apparatus of claim 10, wherein the processor is further configured to perform the feedback loop mechanism by:
performing an evaluation of the CBCABM based on a predetermined evaluation framework with a predetermined performance threshold metric based on a mean and a standard deviation of a rewards distribution.

13. The computing apparatus of claim 8, wherein the CBCABM comprises a reinforcement learning model;
wherein the plurality of learning algorithms comprises a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHN) learning algorithm, a cluster learning algorithm, a radius neighborhood learning algorithm, and a tree bandit learning algorithm; and
wherein the expected reward function comprises an argmax function with an estimated reward term representing an exploitation concept and a confidence interval representing an exploration concept.

14. The computing apparatus of claim 8, wherein the processor is further configured to:
optimize an epsilon-greedy algorithm based on adjusting an epsilon value to provide a balance between an exploitation concept and an exploration concept associated with a performance of the CBCABM.

15. A non-transitory computer readable storage medium storing instructions for generating a contextual-based cluster assignment bandit model for predicting an optimal electronic document sending time, the non-transitory computer readable storage medium comprising executable code which, when executed by a processor, causes the processor to:
receive input data related to an electronic document transmission;
extract contextual features from the input data;
generate a contextual-based cluster assignment bandit model (CBCABM) based on the extracted contextual features representing an arm of the CBCABM and based on a selection of at least one learning algorithm from among a plurality of learning algorithms that maximizes an expected reward function for the CBCABM;
predict an action comprising an optimal electronic document sending time as derived from the CBCABM; and
output the predicted action to a user.

16. The non-transitory computer readable storage medium of claim 15, wherein the input data comprises a user metric, a document attribute, and a historical interaction data;
wherein the user metric comprises a user demographic and a user identification;
wherein the document attribute comprises a document type and an urgency identifier;
wherein the historical interaction data comprises at least one from among a historical sending time, a past action, and a past outcome;
wherein the CBCABM comprises a reinforcement learning model;
wherein the plurality of learning algorithms comprises a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHN) learning algorithm, a cluster learning algorithm, a radius neighborhood learning algorithm, and a tree bandit learning algorithm; and
wherein the expected reward function comprises an argmax function with an estimated reward term representing an exploitation concept and a confidence interval representing an exploration concept.

17. The non-transitory computer readable storage medium of claim 16, wherein the executable code further causes the processor to:
train the CBCABM based on the historical interaction data to estimate a reward associated with the predicted action that maximizes the expected reward function;
perform a feedback loop mechanism as part of the training of the CBCABM; and
update the CBCABM by fine-tuning hyperparameters of the CBCABM in conjunction with an updating rule associated with the selected at least one learning algorithm.

18. The non-transitory computer readable storage medium of claim 17, wherein the updating rule comprises at least one from among a gradient descent function, a distance measurement function, a cosine similarity function, and a probability function; and
wherein the feedback loop mechanism is based on at least one from among a user feedback, a performance evaluation of the CBCABM, and a changing need of a business organization that utilizes the CBCABM.

19. The non-transitory computer readable storage medium of claim 17, wherein the executable code further causes the processor to perform the feedback loop mechanism by:
performing an evaluation of the CBCABM based on a predetermined evaluation framework with a predetermined performance threshold metric based on a mean and a standard deviation of a rewards distribution.

20. The non-transitory computer readable storage medium of claim 15, wherein the executable code further causes the processor to:
optimize an epsilon-greedy algorithm based on adjusting an epsilon value to provide a balance between an exploitation concept and an exploration concept associated with a performance of the CBCABM.
